(19) United States
(12) Patent Application Publication
(10) Pub. No.: US 2025/0097754 A1
(43) Pub. Date: Mar. 20, 2025

(54) SENSING MANNER SWITCHING METHOD AND APPARATUS, COMMUNICATION DEVICE, AND STORAGE MEDIUM

(71) Applicant: VIVO MOBILE COMMUNICATION CO., LTD., Dongguan (CN)

(72) Inventors: Jianzhi LI, Dongguan (CN); Dajie JIANG, Dongguan (CN); Shengli DING, Dongguan (CN)

(73) Assignee: VIVO MOBILE COMMUNICATION CO., LTD., Dongguan (CN)

(21) Appl. No.: 18/963,745

(22) Filed: Nov. 28, 2024

Related U.S. Application Data
(63) Continuation of application No. PCT/CN2023/096091, filed on May 24, 2023.

(30) Foreign Application Priority Data
May 30, 2022 (CN) 202210605844.3

(51) Int. Cl. H04W 24/10; H04W 8/22; H04W 64/00

(52) U.S. Cl. CPC H04W 24/10; H04W 8/22; H04W 64/00

(57) ABSTRACT

A sensing manner switching method and apparatus, a communication device, and a storage medium are provided. The sensing manner switching method includes: obtaining, by a first device, a first measurement report; and determining, by the first device based on the first measurement report, whether to initiate switching of a sensing manner of the sensing target from the first sensing manner to a second sensing manner. The first measurement report is generated by a source node by performing first sensing measurement on a sensing target in a first sensing manner, a signal sending node in the first sensing manner and a signal receiving node in the first sensing manner are a same node, and the first device is the same as or different from the source node. A signal sending node in the second sensing manner and a signal receiving node in the second sensing manner are different nodes.

### CROSS-REFERENCE TO RELATED APPLICATIONS

This application is a continuation of International Application No. PCT/CN 2023/096091, filed on May 24, 2023, which claims priority to Chinese Patent Application No. 202210605844.3, filed on May 30, 2022. The entire contents of each of the above-referenced applications are expressly incorporated herein by reference.

### TECHNICAL FIELD

This application relates to the field of communication sensing technologies, and specifically relates to a sensing manner switching method and apparatus, a communication device, and a storage medium.

### BACKGROUND

In some examples, a sensing node in a mobile communication network generally performs sensing measurement on a sensing target (for example, a specific entity target or a specific area) in a predetermined or preconfigured sensing manner. In some cases (for example, a state of a sensing object changes, an environment of a sensing area changes, or a state of the sensing node changes), the sensing node may not be able to perform accurate sensing measurement on the sensing target, resulting in poor reliability of the sensing measurement.

### SUMMARY

Embodiments of this application provide a sensing manner switching method and apparatus, a communication device, and a storage medium.

According to a first aspect, a sensing manner switching method is provided, and the method includes:
obtaining, by a first device, a first measurement report, where the first measurement report is generated by a source node by performing first sensing measurement on a sensing target in a first sensing manner, a signal sending node in the first sensing manner and a signal receiving node in the first sensing manner are a same node, and the first device is the same as or different from the source node; and
determining, by the first device based on the first measurement report, whether to initiate switching of a sensing manner of the sensing target from the first sensing manner to a second sensing manner, where a signal sending node in the second sensing manner and a signal receiving node in the second sensing manner are different nodes.

According to a second aspect, a sensing manner switching apparatus is provided, applied to a first device, and the apparatus includes:
an obtaining module, configured to obtain a first measurement report, where the first measurement report is generated by a source node by performing first sensing measurement on a sensing target in a first sensing manner, a signal sending node in the first sensing manner and a signal receiving node in the first sensing manner are a same node, and the first device is the same as or different from the source node; and
a first determining module, configured to determine, based on the first measurement report, whether to initiate switching of a sensing manner of the sensing target from the first sensing manner to a second sensing manner, where a signal sending node in the second sensing manner and a signal receiving node in the second sensing manner are different nodes.

According to a third aspect, a sensing manner switching method is provided, and the method includes:
in a case that a sensing manner of a sensing target is initiated to be switched from a first sensing manner to a second sensing manner, receiving, by a first node, a first request message sent by a first device, where the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and
sending, by the first node, a feedback message to the first device, where the feedback message is used to indicate whether the target candidate node agrees to perform sensing measurement on the sensing target in the second sensing manner.

According to a fourth aspect, a sensing manner switching apparatus is provided, applied to a first node, and the apparatus includes:
a first receiving module, configured to: in a case that a sensing manner of a sensing target is initiated to be switched from a first sensing manner to a second sensing manner, receive a first request message sent by a first device, where the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and
a first sending module, configured to send a feedback message to the first device, where the feedback message is used to indicate whether the target candidate node agrees to perform sensing measurement on the sensing target in the second sensing manner.

According to a fifth aspect, a terminal is provided. The terminal includes a processor and a memory, the memory stores a program or an instruction that can be run on the processor, and the program or the instruction is executed by the processor to implement the steps of the method according to the first aspect or the method according to the third aspect.

According to a sixth aspect, a network side device is provided. The network side device includes a processor and a memory, the memory stores a program or an instruction that can be run on the processor, and the program or the instruction is executed by the processor to implement the steps of the method according to the first aspect or the method according to the third aspect.

According to a seventh aspect, a communication device is provided. The communication device is a terminal or a network side device, and the communication device includes a processor and a communication interface. The communication interface is configured to obtain a first measurement report, where the first measurement report is generated by a source node by performing first sensing measurement on a sensing target in a first sensing manner, a signal sending node in the first sensing manner and a signal receiving node in the first sensing manner are a same node, and the first device is the same as or different from the source node; and the processor is further configured to determine, based on the first measurement report, whether to initiate switching of a sensing manner of the sensing target from the first sensing manner to a second sensing manner, where a signal sending node in the second sensing manner and a signal receiving node in the second sensing manner are different nodes.

According to an eighth aspect, a communication device is provided. The communication device is a terminal or a network side device, and the communication device includes a processor and a communication interface. The communication interface is configured to: in a case that a sensing manner of a sensing target is initiated to be switched from a first sensing manner to a second sensing manner, receive a first request message sent by a first device, where the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and the communication interface is further configured to send a feedback message to the first device, where the feedback message is used to indicate whether the target candidate node agrees to perform sensing measurement on the sensing target in the second sensing manner.

According to a ninth aspect, a communication system is provided, including a terminal and a network side device. The terminal may be configured to perform the steps of the sensing manner switching method according to the first aspect or the steps of the sensing manner switching method according to the third aspect. The network side device may be configured to perform the steps of the sensing manner switching method according to the first aspect or the steps of the sensing manner switching method according to the third aspect.

According to a tenth aspect, a readable storage medium is provided. A program or an instruction is stored on the readable storage medium, and the program or the instruction is executed by a processor to implement the steps of the method according to the first aspect or the steps of the method according to the third aspect.

According to an eleventh aspect, a chip is provided. The chip includes a processor and a communication interface, the communication interface is coupled to the processor, and the processor is configured to run a program or an instruction to implement the steps of the method according to the first aspect or the steps of the method according to the third aspect.

According to a twelfth aspect, a computer program/program product is provided. The computer program/program product is stored in a storage medium, and the computer program/program product is executed by at least one processor to implement the steps of the method according to the first aspect or the steps of the method according to the third aspect.

In the embodiments of this application, in a scenario in which a sensing node performs sensing measurement on the sensing target in the first sensing manner, it is determined, based on a measurement report of the sensing node, whether to initiate switching of the sensing manner of the sensing target from the first sensing manner to the second sensing manner. Because a sensing manner used for the sensing measurement may be switched, the sensing measurement can be performed in a proper sensing manner, thereby improving reliability of the sensing measurement.

### BRIEF DESCRIPTION OF DRAWINGS

FIG. 1 is a schematic structural diagram of a network to which embodiments of this application can be applied;

FIG. 2 is a first flowchart of a sensing manner switching processing method according to an embodiment of this application;

FIG. 2a is a schematic diagram of switching a first sensing manner to a second sensing manner;

FIG. 2b is a schematic diagram of switching a second sensing manner to a first sensing manner;

FIG. 2c is a schematic diagram of a plurality of combinations of switching a first sensing manner to a second sensing manner;

FIG. 3 is a first structural diagram of a sensing manner switching processing apparatus according to an embodiment of this application;

FIG. 4 is a second flowchart of a sensing manner switching processing method according to an embodiment of this application;

FIG. 5 is a second structural diagram of a sensing manner switching processing apparatus according to an embodiment of this application;

FIG. 6 is a structural diagram of a communication device according to an embodiment of this application;

FIG. 7 is a structural diagram of a terminal according to an embodiment of this application;

FIG. 8 is a structural diagram of a network side device according to an embodiment of this application; and

FIG. 9 is a structural diagram of another network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In the specification and claims of this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, in the specification and claims, “and/or” represents at least one of connected objects, and a character “/” generally represents an “or” relationship between associated objects.

It should be noted that technologies described in the embodiments of this application are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to applications other than an NR system application, such as a 6th Generation (6G) communication system.

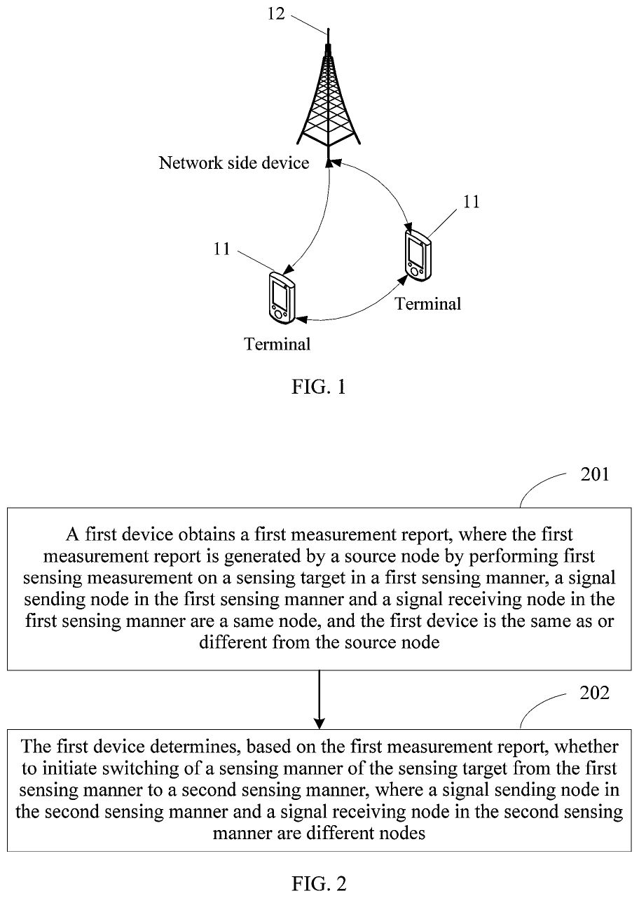

FIG. 1 is a block diagram of a wireless communication system to which the embodiments of this application can be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an ultra-mobile personal computer (UMPC), a Mobile Internet Device (MID), an augmented reality (AR)/virtual reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network node. The access network device may also be referred to as a radio access network device, a Radio Access Network (RAN), a radio access network function, or a radio access network unit. The access network device may include a base station, a Wireless Local Area Networks (WLAN) access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmission Reception Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network node may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized network configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network node in an NR system is used as an example for description, and a specific type of the core network node is not limited.

This application relates to an Integrated Sensing and Communication (ISAC) technology. The following first describes the integrated sensing and communication technology.

Wireless communication and radar sensing have been developing in parallel with limited intersection, and have many commonalities in terms of signal processing algorithms, devices, and system architectures to some extent. In recent years, these two systems have received increasing attention from researchers in terms of coexistence, cooperation, and joint design.

In the early days, people made extensive research on coexistence of the communication system and the radar system. The research focuses on developing an effective interference management technology, so that the two independently deployed systems can run smoothly without mutual interference. Although the radar system and the communication system may be even integrated in a same location physically, the two transmit two different signals in a time/frequency domain. The two systems share same resources through cooperation to minimize interference with each other when working simultaneously. Corresponding measures include beamforming, cooperative spectrum sharing, primary and secondary spectrum sharing, dynamic coexistence, and the like. However, effective interference cancellation generally has strict requirements on node mobility and information exchange between nodes. Therefore, improvement of spectral efficiency is actually limited. Since interference in the coexistence systems is caused by transmitting two independent signals, it is natural to ask whether one transmit signal can be used for both communication and radar sensing. The radar system typically uses specially designed waveforms such as short pulses and chirps to achieve high power radiation and simplify receiver processing. However, these waveforms are not necessary for radar detection. Passive radar or passive sensing using different radio signals as sensing signals is a good example.

Machine learning, especially deep learning, further promotes the potential of non-dedicated radio signals for radar sensing. With these technologies, traditional radar is moving toward more universal wireless sensing. The wireless sensing herein may be broadly referred to as retrieving information from received radio signals rather than modulating communication data into signals at a transmitter. For wireless sensing related to a location of a sensing target, dynamic parameters such as a target signal reflection delay, an angle of arrival (Angle of Arrival, AOA), an angle of departure (Angle of Departure, AOD), and Doppler may be estimated by using a common signal processing method. A physical feature of the sensing target may be implemented by measuring a device, an object, or an inherent mode signal. The two sensing manners may be respectively referred to as sensing parameter estimation and pattern recognition. In this sense, the wireless sensing refers to more general sensing techniques and applications using radio signals.

The integrated sensing and communication technology is a technology that integrates a wireless sensing function into a mobile communication network, and the mobile communication network integrated with the wireless sensing function may be referred to as a Perceptive Mobile Networks (PMNs). The PMN may evolve from a current 5th Generation (5G) mobile network, and may be expected to become a pervasive wireless sensor network to provide a stable and high-quality mobile communication service. The PMN may be built on existing mobile network infrastructures without major changes to network structures and devices. This will unleash the maximum potential of mobile networks and avoid high costs of additional construction of new wide-area wireless sensing networks. With expanded coverage, integrated communication and sensing capabilities are expected to implement many new applications. A sensing mobile network can provide both communication and wireless sensing services, and because of large broadband coverage and robust infrastructure, the sensing mobile network has the potential to become a pervasive wireless sensing solution. Its coordinated communication and sensing capabilities will enhance the productivity of our society and contribute to the emergence of numerous new applications that existing sensor networks cannot effectively achieve. Some early work using mobile signals for passive sensing has already demonstrated its potential, for example, traffic monitoring, weather forecasting, and rainfall remote sensing based on radio signals in a Global System for Mobile Communication (GSM). The sensing mobile network can be widely applied in communication and sensing in the fields of transportation, communication, energy, precision agriculture, and security, while existing solutions are either infeasible or inefficient. The sensing mobile network may also provide complementary sensing capabilities for existing sensor networks, with unique day and night operational capabilities and the ability to penetrate fog, tree leaves, and even solid objects.

In a mobile communication network, a base station (including one or more Transmission Reception Point (TRP)) or User Equipment (UE, also referred to as “terminal”) (including one or more sub-arrays/panels on the terminal) may be used as a sensing node that participates in a sensing service or an integrated sensing and communication service.

A sensing node may implement sensing (or referred to as sensing measurement) on a sensing target by sending and receiving a sensing signal. The sensing target may be a specific area or a specific entity target. The sensing signal may be a signal that does not include transmission information, for example, an LTE/NR synchronization and reference signal, including a synchronization signal and physical broadcast channel block (Synchronization Signal and PBCH block, SSB) signal, a Channel State Information Reference Signal (CSI-RS), a Demodulation Reference Signal (DMRS), a sounding reference signal SRS, a Positioning Reference Signal (PRS), or a Phase-tracking reference signal (PTRS); or may be a single frequency Continuous Wave (CW), a Frequency Modulated CW (FMCW), or an ultra-wideband Gaussian pulse commonly used in radar; or may be a newly designed dedicated sensing signal, for example, a signal with a good correlation characteristic and a low Peak to Average Power Ratio (PAPR), or a newly designed integrated sensing and communication signal that carries specific information and has better sensing performance.

There may be the following two sensing manners: One is a self-transmitting and self-receiving sensing manner. In this sensing manner, a sending node (that is, a signal sending node) of a sensing signal and a receiving node (that is, a signal receiving node) of the sensing signal are a same sensing node, and the sensing node performs sensing by receiving an echo of a signal sent by the sensing node. The other is a sensing manner in which A performs sending and B performs receiving. In this sensing manner, a sending node of a sensing signal and a receiving node of the sensing signal are different sensing nodes. For ease of understanding and description, in the embodiments of this application, the self-transmitting and self-receiving sensing manner is collectively referred to as a first sensing manner, and the sensing manner in which A performs sending and B performs receiving is collectively referred to as a second sensing manner. To simplify description, that a sensing node performs sensing measurement on a sensing target in the first sensing manner may be referred to as that the sensing node performs first sensing on the sensing target, and that a sensing node performs sensing measurement on a sensing target in the second sensing manner may be referred to as that the sensing node performs second sensing on the sensing target.

Currently, a sensing node generally performs sensing measurement on a sensing target in a predetermined or preconfigured sensing manner. For example, the sensing node performs sensing measurement on the sensing target in the first sensing manner, or the sensing node performs sensing measurement on the sensing target in the second sensing manner. However, in some cases (for example, a state of a sensing object changes, an environment of a sensing area changes, or a state of the sensing node changes), the sensing node may not be able to perform accurate sensing measurement on the sensing target, resulting in poor reliability of the sensing measurement.

Based on this, the embodiments of this application provide a sensing manner switching method, a sensing manner switching apparatus, a first device, a first node, and a storage medium.

With reference to the accompanying drawings, the following describes in detail the sensing manner switching method, the sensing manner switching apparatus, the first device, the first node, and the storage medium provided in the embodiments of this application by using some embodiments and application scenarios thereof.

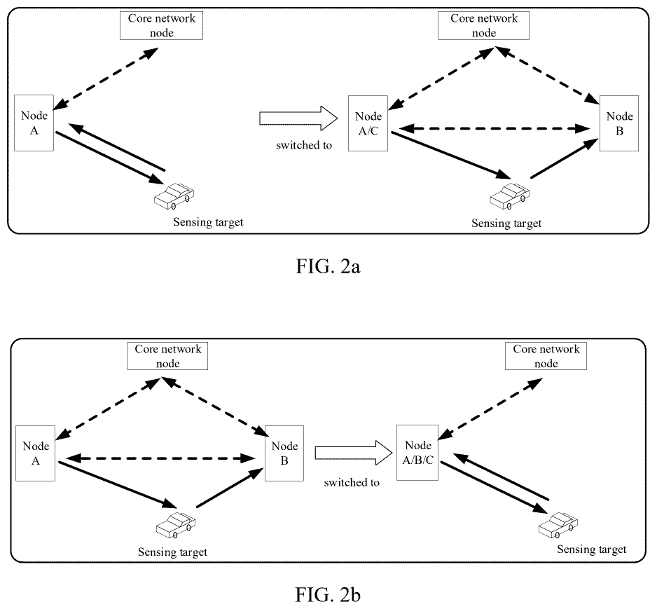

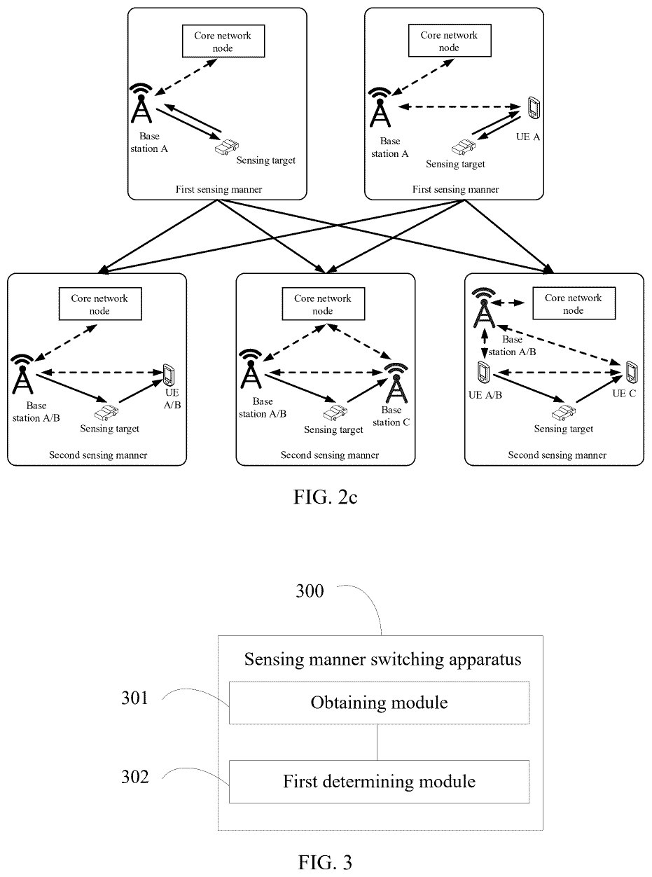

FIG. 2 is a flowchart of a sensing manner switching method according to an embodiment of this application. As shown in FIG. 2, the sensing manner switching method includes the following steps.

Step 201: A first device obtains a first measurement report, where the first measurement report is generated by a source node by performing first sensing measurement on a sensing target in a first sensing manner, a signal sending node in the first sensing manner and a signal receiving node in the first sensing manner are a same node, and the first device is the same as or different from the source node.

Step 202: The first device determines, based on the first measurement report, whether to initiate switching of a sensing manner of the sensing target from the first sensing manner to a second sensing manner, where a signal sending node in the second sensing manner and a signal receiving node in the second sensing manner are different nodes.

In this embodiment of this application, the sensing manner of the sensing target is switched from the first sensing manner to the second sensing manner, a sensing node that performs first sensing on the sensing target before switching may be referred to as the source node, and the first device may be the source node or may be another node. In other words, the source node may independently determine, based on the first measurement report (the measurement report may be referred to as a “switching measurement report”), whether to initiate switching of the sensing manner, or an access node or a core network node of the source node determines, based on the first measurement report of the source node, whether to initiate switching of the sensing manner. In this case, the access node or the core network node of the source node receives the first measurement report sent by the source node, and determines, based on the first measurement report, whether to initiate switching of the sensing manner. The sensing target may be a specific area or a specific entity target.

The first sensing measurement in this embodiment of this application may be understood as “switching measurement” performed by the source node to obtain the first measurement report.

It should be noted that, for the sensing target, a single group of sensing nodes may perform sensing measurement, or a plurality of groups of sensing nodes may cooperate to perform sensing measurement. For example, before switching, there may be one or more source nodes that perform first sensing on the sensing target, and each source node performs first sensing on the sensing target. The initiated switching may be initiating switching from performing first sensing on the sensing target by a source node to performing second sensing on the sensing target by one or more pairs of sensing nodes.

In this embodiment of this application, in a scenario in which the source node performs sensing measurement on the sensing target in the first sensing manner, the first device determines, based on the first measurement report, whether to initiate switching of the sensing manner of the sensing target from the first sensing manner to the second sensing manner. Based on the first measurement report, the first device can properly determine whether it is necessary to initiate switching of the sensing manner of the sensing target from the first sensing manner to the second sensing manner, so that the source node can be prevented from performing invalid sensing measurement on the sensing target in the inherent first sensing manner. Because a sensing manner used for the sensing measurement may be switched, the sensing measurement can be performed in a proper sensing manner, thereby improving reliability of the sensing measurement.

In some embodiments, the first device includes any one of the following:
in a case that the source node is a first network side device, the first device includes a core network node or the first network side device; and
in a case that the source node is a first terminal, the first device includes a core network node, the first terminal, or a second network side device accessed by the first terminal.

The core network node may be, for example, a Sensing Function (SF) network element, an AMF, or a core sensing application server.

Content of the first measurement report may be set based on an actual requirement. For example, in some embodiments, the first measurement report includes at least one of the following:
at least one measurement value of a sensing measurement quantity;
at least one measurement result of a sensing performance evaluation indicator;
at least one measurement value of a communication measurement quantity;
at least one measurement result of a communication performance evaluation indicator;
first indication information used to indicate whether a preset event occurs, where the preset event is used to trigger the initiation of switching the sensing manner of the sensing target from the first sensing manner to the second sensing manner; and
second indication information used to indicate whether a preset switching condition is met, where the preset switching condition is used to trigger the initiation of switching the sensing manner of the sensing target from the first sensing manner to the second sensing manner.

In some examples, the first measurement report includes at least a measurement value (or a measurement result) of a sensing measurement quantity required for switching measurement, and the sensing measurement quantity required for switching measurement may include a sensing measurement quantity of a current sensing service.

The sensing measurement quantity in this embodiment of this application may include at least one of the following:
a first-level measurement quantity (also referred to as received signal/raw channel information), for example, may include a complex result, an amplitude/a phase, and an I channel/a Q channel of a received signal/channel response and arithmetic results thereof (arithmetic operations may include addition, subtraction, multiplication, division, matrix addition, matrix subtraction, matrix multiplication, matrix transpose, a trigonometric operation, a square root operation, a power operation, and the like, as well as threshold detection results, and maximum/minimum value extraction results of the above arithmetic results; or arithmetic operations may include Fast Fourier Transform (FFT)/Inverse Fast Fourier Transform (IFFT), Discrete Fourier Transform (DFT)/Inverse Discrete Fourier Transform (IDFT), two-dimensional Fast Fourier Transform (2D-FFT), three-dimensional Fast Fourier Transform (3D-FFT), matched filtering, an autocorrelation operation, wavelet transform, digital filtering, and the like, as well as threshold detection results, and maximum/minimum value extraction results of the above arithmetic results);
a second-level measurement quantity (also referred to as a basic measurement quantity), for example, may include a time delay, Doppler, an angle, a strength, and a multidimensional combination thereof;
a third-level measurement quantity (also referred to as a basic attribute/state), for example, may include at least one of a distance, a speed, an orientation, a spatial location, and an acceleration; and
a fourth-level measurement quantity (also referred to as an advanced attribute/state), for example, may include at least one of whether the sensing target exists, and a track, an action, an expression, a vital sign, a quantity, an imaging result, a weather, air quality, a shape, a material, and a composition of the sensing target.

In some embodiments, the sensing measurement quantity further includes corresponding label information, for example, may include at least one of the following: sensing signal identifier information, sensing measurement configuration identifier information, sensing service information (for example, a sensing service ID), a data subscription ID, a measurement quantity usage (for example, communication, sensing, and sensing and communication), time information, sensing node information (for example, a node ID, a node location, and a device orientation), sensing link information (for example, a sensing link sequence number and a transceiver node identifier), sensing measurement quantity description information (a form, for example, an amplitude value, a phase value, and a complex value of a combination of an amplitude and a phase; and a resource type, for example, a time domain measurement result, and a frequency domain resource measurement result), and measurement quantity indicator information (for example, a Signal Noise Ratio (SNR) and a sensing SNR).

The sensing performance evaluation indicator in this embodiment of this application may include at least one of the following:
a sensing SNR, representing a ratio of energy of a sensing signal reflected by a sensing target or a sensing area to energy of a noise signal in an environment and a device;
a signal to interference plus noise ratio (SINR), representing a ratio of energy of a sensing signal reflected by a sensing target or a sensing area to energy of an interference signal and a noise signal in an environment and a device;
a statistical mean, a standard deviation, or a variance of a plurality of measurement values of a same sensing measurement quantity;
a deviation between a measurement value of a sensing measurement quantity or a prediction value of a sensing result and an actual measurement value, and a statistical mean, a standard deviation, or a variance of the deviation; and
a sensing reproducible evaluation indicator, for example, a sum of inter-sample Euclidean distances in two consecutive sequences, or a warping path distance in dynamic time warping (DTW), or other indicators that can reflect similarity between two sequences, where the other indicators that can reflect similarity between two sequences include but are not limited to: a longest common subsequence (LCSS), an edit distance on real sequence (EDR), an edit distance with real penalty (ERP), a Hausdorff distance, a Frechet distance, a one way distance (OWD), and locality in-between polylines (LIP).

In some embodiments, the first device is different from the source node; and
before the obtaining, by a first device, a first measurement report, the method further includes:
sending, by the first device, a first measurement request to the source node, where the first measurement request is used to request the source node to perform the first sensing measurement on the sensing target in the first sensing manner; and
the obtaining, by a first device, a first measurement report includes:
receiving, by the first device, the first measurement report sent by the source node, where the first measurement report is generated by the source node based on the first sensing measurement.

In some embodiments, the first device may trigger switching measurement based on the target event, that is, the first device may send the first measurement request to the source node based on trigger by the target event. In other words, the sending, by the first device, a first measurement request to the source node includes: sending, by the first device, the first measurement request to the source node in a case that the first device determines that a target event occurs. Herein, the target event may include at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a first preset threshold; and
a measurement value of a communication measurement quantity of the source node reaches a second preset threshold.

That a state of the sensing target changes may include, for example, at least one of the following: a location of the sensing target changes, and a speed of the sensing target changes.

That an environment of a sensing area in which the sensing target is located changes may be, for example, the sensing area is blocked.

That an available sensing resource of the source node changes may be, for example, another high-priority sensing service, communication service, or integrated sensing and communication service bursts on the source node. In this case, the first device may evaluate, based on a remaining available sensing resource of the source node, whether it is necessary to initiate switching of the sensing manner. In a case that it is determined that switching of the sensing manner needs to be initiated, the first device sends the first measurement request to the source node based on the target event.

The first preset threshold may be understood that switching thresholds corresponding to different sensing measurement quantities are included. That a measurement value of a sensing measurement quantity of the source node reaches a first preset threshold may be understood as that at least one of a sensing signal received power, a sensing SNR, a sensing Signal to Interference plus Noise Ratio (SINR), a distance measurement value, a speed measurement value, and an angle measurement value meets a corresponding switching threshold.

The communication measurement quantity may include at least one of the following: a reference signal received power (RSRP), an SNR, an SINR, reference signal received quality (RSRQ), a received signal strength indicator (RSSI), a bit error rate, block error rate, a throughput, spectrum efficiency, and the like.

In some embodiments, before the obtaining, by a first device, a first measurement report, the method further includes:
sending, by the first device, first measurement configuration information to the source node, where the first measurement configuration information is used by the source node to perform the first sensing measurement.

The first measurement configuration information may also be referred to as switching measurement configuration information, and the first measurement configuration information may include at least one of the following:
measurement object indication information used to indicate one or more first signals that need to be measured, where the first signal may be associated with at least one of a sensing measurement quantity and sensing parameter configuration information;
measurement report configuration information, for example, a reporting principle of a measurement report and a reporting format of a measurement report, where the reporting principle of the measurement report may include a periodic reporting or event trigger principle, and the reporting format of the measurement report may include a maximum quantity of reported cells, a quantity of beams, and the like;
target event configuration information used to trigger execution of the first sensing measurement; and
a measurement identifier (that is, a measurement ID), where each measurement identifier may correspond to one measurement object and one piece of measurement report configuration information.

Before the source node performs the first sensing measurement on the sensing target in the first sensing manner, the first device may first send the first measurement request to the source node, and after the first device receives an acknowledgement from the source node, the first device sends the first measurement configuration information to the source node.

In some embodiments, the first measurement configuration information is included in the first measurement request. In this way, before the source node performs the first sensing measurement on the sensing target in the first sensing manner, the first device may send the first measurement request to the source node, where the first measurement configuration information is included in the first measurement request. Therefore, signaling and resource waste can be moderately reduced.

In some embodiments, the first device is the same as the source node; and
after the obtaining, by a first device, a first measurement report, the method further includes:
sending, by the first device, the first measurement report to a second device, where the second device includes a core network node or a network side device accessed by the source node.

In a case that the first device is the same as the source node, that is, the source node independently performs the first sensing measurement to obtain the first measurement report, the first device (that is, the source node) may further send the first measurement report to the network side device or the source node accessed by the core network node. For example, in a case that the source node is a network side device, the source node may send the first measurement report to the core network node. In a case that the source node is a terminal, the source node may send the first measurement report to the core network node or the network side device accessed by the source node.

In some embodiments, the first device is the same as the source node; and
the obtaining, by a first device, a first measurement report includes:
obtaining, by the first device, the first measurement report in a case that it is determined that a target event occurs, where
the target event includes at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a third preset threshold; and
a measurement value of a communication measurement quantity of the source node reaches a fourth preset threshold.

In this implementation, in a case that it is determined that the target event occurs, the source node may independently perform the first sensing measurement to obtain the first measurement report. For the target event in this implementation, refer to the foregoing related descriptions about the target event. To avoid repetition, details are not described again.

In some embodiments, the method further includes:
sending, by the first device, a first request message to N first candidate nodes in a case that the first device determines to initiate switching of the sensing manner of the sensing target from the first sensing manner to the second sensing manner, where the first request message is used to request at least one target candidate node to perform sensing measurement on the sensing target in the second sensing manner, and N is an integer greater than or equal to 1; and
receiving, by the first device, a feedback message sent by at least one of the N first candidate nodes, where the feedback message is used to indicate whether the target candidate node agrees to perform sensing measurement on the sensing target in the second sensing manner.

The feedback message may be understood as a response message for the first request message and is sent by the first candidate node to the first device. In a case that the feedback message indicates that the target candidate node agrees to perform sensing measurement on the sensing target in the second sensing manner, the feedback message may be referred to as an acknowledgement message. In a case that the feedback message indicates that the target candidate node does not agree to perform sensing measurement on the sensing target in the second sensing manner, the feedback message may be referred to as a reject message.

The first candidate node may be a network side device or may be a terminal. The first candidate node may be understood as a node that may perform sensing measurement on the sensing target in the second sensing manner, or an access node of a node that may perform sensing measurement on the sensing target in the second sensing manner. The N first candidate nodes may include the source node or may not include the source node. In a case that the first device is different from the source node, the N first candidate nodes may include the source node.

The target candidate node may be understood as a node that may perform sensing measurement on the sensing target in the second sensing manner. In a case that the first candidate node is a node that may perform sensing measurement on the sensing target in the second sensing manner, the target candidate node may be understood as the first candidate node. In this case, it may be understood that the first request message is used to request the at least one first candidate node to perform sensing measurement on the sensing target in the second sensing manner. However, in a case that the first candidate node is an access node of a node that may perform sensing measurement on the sensing target in the second sensing manner, the target candidate node may be understood as a node that is selected by the first candidate node and that may perform sensing measurement on the sensing target in the second sensing manner.

For example, assuming that the first device determines to initiate switching of the sensing manner of the sensing target from the first sensing manner to the second sensing manner to be performed by a terminal, the first device may directly send the first request message to N candidate terminals to request at least one candidate terminal to perform sensing measurement on the sensing target in the second sensing manner, or the first device may send the first request message to N candidate network side devices to request at least one candidate terminal from the candidate network side device to perform sensing measurement on the sensing target in the second sensing manner.

For another example, assuming that the first device determines to initiate switching of the sensing manner of the sensing target from the first sensing manner to the second sensing manner to be performed a network side device, the first device may directly send the first request message to N candidate network side devices to request at least one candidate network side device to perform sensing measurement on the sensing target in the second sensing manner.

In some embodiments, the method further includes:
determining, by the first device, an interaction type of the second sensing manner in a case that it is determined to initiate switching of the sensing manner of the sensing target from the first sensing manner to the second sensing manner; and
the sending, by the first device, a first request message to N first candidate nodes includes:
sending, by the first device, the first request message to the N first candidate nodes based on the interaction type of the second sensing manner, where
the interaction type of the second sensing manner includes any one of the following:
a first interaction type, where the signal sending node and the signal receiving node in the second sensing manner are two different network side devices, that is, one of the signal sending node and the signal receiving node is a network side device and the other is another network side device;
a second interaction type, where one of the signal sending node and the signal receiving node in the second sensing manner is a network side device and the other is a terminal; and
a third interaction type, where the signal sending node and the signal receiving node in the second sensing manner are two different terminals, that is, one of the signal sending node and the signal receiving node is a terminal and the other is another terminal.

In the second sensing manner, a receiving node and a sending node that are of a sensing signal are different from, and there are a plurality of different combinations of the receiving node and the sending node that are of the sensing signal. In the second sensing manner, a combination type of the receiving node and the sending node that are of the sensing signal may be understood as the interaction type of the second sensing manner.

In a case that it is determined to initiate switching of the sensing manner of the sensing target from the first sensing manner to the second sensing manner, the first device may determine the interaction type of the second sensing manner, and send the first request message to the N first candidate nodes based on the interaction type of the second sensing manner.

For example, assuming that the determined interaction type of the second sensing manner is the first interaction type, the first device may send first request information to N candidate network side devices instead of sending the first request information to N candidate terminals.

The first request message may include indication information of the interaction type of the second sensing manner, which is used to instruct to perform second sensing of an interaction type after the switching of the sensing manner is completed. For example, the first request message includes indication information of the first interaction type, which is used to instruct to perform second sensing of a network side device-a network side device after the switching of the sensing manner is completed.

In some embodiments, the first request message includes at least one of the following:
indication information of a sensing requirement, used to indicate, for example, an area of the sensing target, an object type of the sensing target, and a required sensing function, a sensing purpose, and a sensing result that are of the sensing target;
indication information of sensing quality of service (QoS), used to indicate at least one of the following information: a sensing resolution (which may further be divided into a ranging resolution, an angular resolution, a velocity resolution, an imaging resolution, and the like), sensing accuracy (which may further be divided into ranging accuracy, angular accuracy, velocity accuracy, positioning accuracy, and the like), a sensing range (which may further be divided into a ranging range, a velocity range, an angular range, an imaging range, and the like), a sensing delay (for example, a time interval between sending of a sensing signal and obtaining of a sensing result or a time interval from initiation of a sensing requirement to obtaining of a sensing result), a sensing update rate (for example, a time interval between two consecutive executions of sensing and obtaining of sensing results), a detection probability (for example, a probability of correctly detecting presence of a sensing object), a false alarm probability (for example, a probability of falsely detecting a sensing target in the absence of a sensing object), sensing security, and sensing privacy;
indication information of a sensing measurement quantity, used to indicate one or more sensing measurement quantities;
indication information of a sensing measurement result, used to indicate a sensing result directly or indirectly obtained based on at least one measurement value of a sensing measurement quantity;
indication information of a sensing condition, used to indicate at least one of a sensing start time, a sensing end time, and sensing duration;
prior information of a sensing target or a sensing area, used to indicate at least one of a type of the sensing target, an approximate location or area in which the sensing target is located, and a historical state (for example, a speed, an angle, a distance, an acceleration, or a spatial orientation) of the sensing target; and
indication information of a condition for determining that the sensing manner is successfully switched, used to indicate a preset threshold that is to be reached by at least one measurement value of a sensing measurement quantity and/or a measurement result of a communication measurement quantity within a preset time period or for a preset quantity of times.

In some embodiments, the first device determines the N first candidate nodes based on at least one of the following:
location information of a candidate node;
antenna panel orientation information of a candidate node;
state information of a candidate node;
sensing capability information of a candidate node;
information about an available sensing resource of a candidate node; and
channel state information of a candidate node.

For example, in a case that the N first candidate nodes include at least one candidate terminal, the first device may determine the candidate terminal based on at least one of the following:
location information of the candidate terminal;
antenna panel orientation information of the candidate terminal;
state information of the candidate terminal, for example, may include information such as a moving speed, a moving direction, and a time period of keeping still/moving;
sensing capability information of the candidate terminal, for example, may include a sensing coverage area of the terminal, a maximum bandwidth available for sensing, maximum duration of a sensing service, a supported sensing signal type and frame format, and antenna array information of the terminal (for example, an array type, an antenna quantity, an array aperture, an antenna polarization characteristic, an array element gain, and a directional characteristic);
information about resources that may be currently used by the candidate terminal for sensing, for example, may include at least one of a time resource (a quantity of symbols, a quantity of slots, a quantity of frames, or the like), a frequency resource (for example, a quantity of resource blocks (RB), a quantity of resource elements (RE), a total bandwidth, a location of an available band, or the like), an antenna resource (for example, a quantity of antenna arrays/a quantity of antenna subarrays), a phase modulation resource (for example, a quantity of hardware phase shifters), and an orthogonal code resource (for example, a length of an orthogonal code and a quantity of orthogonal codes); and
channel state information of the candidate terminal, for example, may include at least one of a channel transmission function/channel impulse response, a channel quality indicator (CQI), a precoding matrix indicator (PMI), a CSI-RS resource indicator, an SSB resource indicator, a layer indicator (LI), a rank indicator (RI), and an L1-reference signal received power (L1-RSRP) of at least one communication link.

For example, in a case that the N first candidate nodes include at least one candidate network side device, the first device may determine the candidate network side device based on at least one of the following:
location information of the candidate network side device;
antenna panel orientation information of the candidate network side device;
sensing capability information of the candidate network side device, for example, may include a sensing coverage area of the network side device, a maximum bandwidth available for sensing, maximum duration of a sensing service, a supported sensing signal type and frame format, and antenna array information of the network side device (for example, an array type, an antenna quantity, an array aperture, an antenna polarization characteristic, an array element gain, and a directional characteristic);
information about resources that may be currently used by the candidate network side device to perform sensing, for example, may include at least one of a time resource (a quantity of symbols, a quantity of slots, a quantity of frames, or the like), a frequency resource (for example, a quantity of RBs, a quantity of REs, a total bandwidth, a location of an available band, or the like), an antenna resource (for example, a quantity of antenna arrays/a quantity of antenna subarrays), a phase modulation resource (for example, a quantity of hardware phase shifters), and an orthogonal code resource (for example, a length of an orthogonal code and a quantity of orthogonal codes); and
channel state information of the candidate network side device, for example, may include at least one of a channel transmission function/channel impulse response, a CQI, a PMI, a CSI-RS resource indicator, an SSB resource indicator, an LI, an RI, and an L1-RSRP of at least one communication link.

In some embodiments, the feedback message includes at least one of the following:
a first feedback message determined by the first candidate node based on the first request message and used to indicate whether the first candidate node agrees to perform sensing measurement on the sensing target in the second sensing manner, where the target candidate node includes the first candidate node; and
a second feedback message determined by a second candidate node based on a second request message sent by the first candidate node and used to indicate whether the second candidate node agrees to perform sensing measurement on the sensing target in the second sensing manner, where the second request message is used to request the second candidate node to perform sensing measurement on the sensing target in the second sensing manner, and the target candidate node includes the second candidate node.

It may be understood that the first feedback message is directly determined by the first candidate node based on the first request message, is used to indicate whether the first candidate node agrees to perform sensing measurement on the sensing target in the second sensing manner, and is fed back by the first candidate node to the first device. It may be understood that the second feedback message is determined by the second candidate node based on the second request message, is used to indicate whether the second candidate node agrees to perform sensing measurement on the sensing target in the second sensing manner, and is fed back by the first candidate node to the first device.

The second candidate node may be a node that is associated with the first candidate node and that performs sensing measurement on the sensing target in the second sensing manner together with the first candidate node, or may be selected by the first candidate node and configured to perform sensing measurement on the sensing target in the second sensing manner. For ease of understanding, the following provides descriptions by using examples.

Example 1: The first device sends the first request message to a first candidate network side device (that is, the first candidate node and also the target candidate node), to request to perform second sensing of a network side device-a network side device after the switching of the sensing manner is completed. The first candidate network side device sends the first feedback message to the first device based on the first request message, to indicate whether the first candidate network side device agrees to perform sensing measurement on the sensing target in the second sensing manner.

Example 2: The first device sends the first request message to a first candidate network side device (that is, the first candidate node and also the target candidate node), to request to perform second sensing of a network side device-a network side device after the switching of the sensing manner is completed. The first candidate network side device sends the first feedback message to the first device based on the first request message, to indicate whether the first candidate network side device agrees to perform sensing measurement on the sensing target in the second sensing manner.

In addition, the first candidate network side device sends the second request message to a second candidate network side device (that is, the second candidate node and also the target candidate node), to request the second candidate network side device to perform sensing measurement on the sensing target in the second sensing manner. The second candidate network side device sends a feedback message to the first candidate network side device based on the second request message, to indicate whether the second candidate network side device agrees to perform sensing measurement on the sensing target in the second sensing manner. The first candidate network side device sends the second feedback message to the first device based on the feedback message fed back by the second candidate network side device, to indicate whether the second candidate network side device agrees to perform sensing measurement on the sensing target in the second sensing manner.

Example 3: In a case that the first device determines to initiate switching of the sensing manner of the sensing target from the first sensing manner to the second sensing manner, the first device sends the first request message to a first candidate network side device (that is, the first candidate node), to request to perform second sensing of a terminal-a terminal after the switching of the sensing manner is completed.

The first candidate network side device sends the second request message to a first candidate terminal and a second candidate terminal (that is, the second candidate node and also the target candidate node) based on the first request message, to request the first candidate terminal and the second candidate terminal to perform sensing measurement on the sensing target in the second sensing manner. The candidate terminal sends a feedback message to the first candidate network side device based on the second request message, to indicate whether the candidate terminal agrees to perform sensing measurement on the sensing target in the second sensing manner. The first candidate network side device sends the second feedback message to the first device based on the feedback message fed back by the candidate terminal, to indicate whether the candidate terminal agrees to perform sensing measurement on the sensing target in the second sensing manner.

Example 4: In a case that the first device determines to initiate switching of the sensing manner of the sensing target from the first sensing manner to the second sensing manner, the first device sends the first request message to a first candidate network side device (that is, the first candidate node and also the target candidate node), to request the first candidate network side device to perform second sensing of a network side device-a terminal after the switching of the sensing manner is completed.

The first candidate network side device sends the second request message to a first candidate terminal (that is, the second candidate node and also the target candidate node) based on the first request message, to request the first candidate terminal to perform sensing measurement on the sensing target in the second sensing manner. The first candidate terminal sends a feedback message to the first candidate network side device based on the second request message, to indicate whether the first candidate terminal agrees to perform sensing measurement on the sensing target in the second sensing manner. The first candidate network side device sends the second feedback message to the first device based on the feedback message fed back by the first candidate terminal, to indicate whether the first candidate terminal agrees to perform sensing measurement on the sensing target in the second sensing manner.

In some embodiments, in a case that the feedback message is used to indicate that the target candidate node agrees to perform sensing measurement on the sensing target in the second sensing manner, the feedback message further includes first parameter configuration information, and the first parameter configuration information is sensing parameter configuration information used to instruct the target candidate node to perform sensing measurement on the sensing target.

The first parameter configuration information may be understood as sensing parameter configuration information recommended by the target candidate node, and the first parameter configuration information may be used to configure at least one of the following:
a waveform type, for example, at least one of orthogonal frequency division multiplexing (OFDM), single carrier frequency division multiple access (SC-FDMA), an orthogonal time frequency space (OTFS), a frequency modulated continuous wave (FMCW), and a pulse signal;
a subcarrier spacing, for example, a subcarrier spacing of an OFDM system, for example, 30 KHz;
a guard interval, for example, a time interval between a moment at which sending of a signal ends and a moment at which a latest echo signal of the signal is received, where this parameter is proportional to a maximum sensing distance, for example, may be obtained by 2dₘₐₓ/c through calculation, where dₘₐₓ represents a maximum sensing distance (belonging to a sensing requirement), and for a self-transmitting and self-receiving sensing signal, dₘₐₓ represents a maximum distance between a receiving point of a sensing signal and a transmission point of the signal, and in some cases, a cyclic prefix (CP) of an OFDM signal may be used to indicate a minimum guard interval;
a bandwidth, where this parameter is inversely proportional to a distance resolution and may be obtained by c/(2Δd), where Δd represents the distance resolution (belonging to a sensing requirement), and c represents a speed of light;
burst duration, where this parameter is inversely proportional to a rate resolution (belonging to a sensing requirement), and this parameter is a time span of a sensing signal and is mainly used to calculate a Doppler offset, and this parameter may be obtained by c/(2f_{c}Δv) through calculation, where Δv represents the rate resolution, and f_{c} represents a carrier frequency of the sensing signal;
a time domain interval, where this parameter may be obtained by c/(2f_{c}v_{range}) through calculation, where v_{range} represents a maximum velocity minus a minimum velocity (belonging to a sensing requirement), and this parameter is a time interval between two adjacent sensing signals;
a transmit signal power, for example, a value taken every 2 dBm from −20 dBm to 23 dBm;
a signal format, for example, information such as an SRS, a DMRS, a PRS, or another predefined signal and a related sequence format;
a signal direction, for example, a direction or beam information of a sensing signal;
a time resource, for example, an index of a slot in which a sensing signal is located or a symbol index of the slot, where the time resource is divided into two types, one is a one-time time resource, for example, a symbol sends an omnidirectional sensing signal, and the other is non-one-time time resources, for example, a plurality of groups of periodic time resources or discontinuous time resources (which may include a start time and an end time), each group of periodic time resources send sensing signals in a same direction, and beam directions on different groups of periodic time resources are different;
a frequency resource, including a center frequency, a bandwidth, an RB or a subcarrier, a reference point A, a start bandwidth location, and the like of a sensing signal;
a quasi co-location (QCL) relationship, for example, a sensing signal includes a plurality of resources, each resource corresponds to one SSB QCL, and the QCL includes a Type A, a Type B, a Type C, or a Type D; and
antenna configuration information.

In some embodiments, the antenna configuration information may include at least one of the following:
an ID of an antenna array element or an antenna port used to send and/or receive a sensing signal;
an ID of a panel and an ID of an array element that are used to send and/or receive a sensing signal;
location information (which may be represented by Cartesian coordinates (x, y, z) or spherical coordinates) of an antenna array element used to send and/or receive a sensing signal relative to a local reference point on an antenna array;
location information (which may be represented by Cartesian coordinates (x, y, z) or spherical coordinates) of a panel used to send and/or receive a sensing signal relative to a local reference point on an antenna array, and location information (which may be represented by Cartesian coordinates (x, y, z) or spherical coordinates) of an antenna array element used to send a sensing signal in the selected panel relative to a unified reference point (for example, a panel center point) on the panel;
bitmap information of an antenna array element, for example, “1” is used to indicate that the array element is selected for sending and/or receiving a sensing signal, and “0” is used to indicate that the array element is not selected, or vice versa;
bitmap information of an array panel, for example, “1” is used to indicate that the panel is selected for sending and/or receiving a sensing signal, and “0” is used to indicate that the panel is not selected, or vice versa; and
bitmap information of an array panel and bitmap information of an array element in the selected panel, for example, “1” is used to indicate that the array element is selected for sending and/or receiving a sensing signal, and “0” is used to indicate that the array element is not selected, or vice versa.

In some embodiments, after the sending, by the first device, a first request message to N first candidate nodes, the method further includes:
sending, by the first device, a first indication message to a second device, where the second device includes a core network node, the source node, or a source access base station of the source node, and the first indication message is used to indicate that the sensing manner of the sensing target is switched from the first sensing manner to the second sensing manner.

In some embodiments, in a case that the feedback message is used to indicate that the target candidate node disagrees to perform sensing measurement on the sensing target in the second sensing manner, or in a case that the first device does not receive the feedback message within the preset waiting time period, the method further includes any one of the following:
re-determining, by the first device, a candidate node; and
cancelling the switching and maintaining the current first sensing; or
cancelling the switching and ending the current first sensing.

In some embodiments, in a case that the feedback message is used to indicate that the target candidate node agrees to perform sensing measurement on the sensing target in the second sensing manner, the method further includes:
determining, by the first device, M target nodes from the target candidate node based on the feedback message, where M is an integer greater than or equal to 1; and
sending, by the first device, a first notification message to the M target nodes, where the first notification message is used to instruct the M target nodes to perform sensing measurement on the sensing target in the second sensing manner.

The first notification message may be understood as a switching acknowledgment message or a switching command. After receiving the first notification message, the target node acknowledges that the sensing manner of the sensing target is switched from the first sensing manner to the second sensing manner, and the target node may perform sensing measurement on the sensing target in the second sensing manner.

It should be noted that in this embodiment of this application, the first device may directly determine or select the target node from the target candidate node based on the feedback message. In other words, the first device may directly determine, from the target candidate node based on the obtained information, a target node that can meet a sensing requirement or a sensing QoS requirement.

In some embodiments, the first device is the same as the source node; and
one of the M target nodes is the source node or none of the M target nodes is the source node.

It should be noted that a quantity of target nodes determined by the first device may be 1 (applicable to a case that the source node is still used as the target node), or may be 2 (applicable to a case that the source node is no longer used as the target node), or may be greater than 2 (applicable to a case that a plurality of pairs of sensing nodes cooperate to perform second sensing on the sensing target, that is, A1 performs sending and B1 performs receiving, and A2 performs sending and B2 performs receiving).

In some embodiments, the first notification message includes second parameter configuration information, and the second parameter configuration information is sensing parameter configuration information used to instruct the target node to perform sensing measurement on the sensing target.

The second parameter configuration information may be understood as sensing parameter configuration information recommended by the first device, and information included in the second parameter configuration information may be the same as that included in the first parameter configuration information. To avoid repetition, details are not described again.

It should be noted that, in a case that a plurality of pieces of parameter configuration information exist, for example, in a case that the first parameter configuration information and the second parameter configuration information exist, when performing sensing measurement on the sensing target, the target node may perform sensing measurement based on the second parameter configuration information, or may perform sensing measurement based on the first parameter configuration information, or may separately perform sensing measurement based on a part of the first parameter configuration information and the second parameter configuration information.

In some embodiments, the method further includes:
sending, by the first device, first information to the M target nodes, where the first information includes at least one of the following:
a value of historical measurement on a sensing measurement quantity of the sensing target by the source node;
a result of historical sensing on the sensing target by the source node;
indication information of the sensing target; and
prior information of a sensing area in which the sensing target is located.

Before the sensing manner is switched, the sensing measurement quantity in the first information may be the same as or different from a sensing measurement quantity after the sensing switching is completed. After determining the target node, the first device sends the first information to the target node, so as to assist the target node in performing sensing measurement on the sensing target, thereby further improving sensing performance.

In some embodiments, the first device is different from the source node, and the method further includes:
sending, by the first device, a second notification message to the source node, where the second notification message is used to instruct the source node to stop performing sensing measurement on the sensing target in the first sensing manner.

The second notification message may also be referred to as an end command. In a case that the source node no longer participates in a sensing operation after the switching (that is, the target node does not include the source node), the first device sends the second notification message to the source node, so that after receiving the second notification message, the source node stops performing sensing measurement on the sensing target in the first sensing manner, thereby reducing a power loss of the source node.

For the source node, if the source node no longer performs second sensing as the target node, after receiving the second notification message, the source node may stop performing first sensing on the sensing target, and release resources occupied for the sensing, for example, a time-frequency resource and an antenna port resource. If the second sensing still performs second sensing as the target node, after receiving the second notification message, the second sensing may stop only performing first sensing on the sensing target, without releasing resources occupied for the sensing.

In addition, there may be a plurality of options for an occasion on which the first device sends the second notification message to the source node. For example, once determining the target node, the first device may send the second notification message to the source node without considering whether the sensing switching succeeds. A sensing switching mode corresponding to this manner may be referred to as a hard switching mode.

In some embodiments, the sending, by the first device, a second notification message to the source node includes:
sending, by the first device, the second notification message to the source node in a case that a third notification message is received, where the third notification message is used to indicate that the target node performs at least one sensing measurement on the sensing target in the second sensing manner and obtains at least one measurement value of a sensing measurement quantity or at least one sensing result.

The third notification message may also be referred to as a switching success message, and is used to indicate that the target node successfully performs sensing measurement on the sensing target in the second sensing manner, for example, the at least one sensing measurement, and obtains the at least one measurement value of the sensing measurement quantity or the at least one sensing result.

In this implementation, an occasion on which the first device sends the second notification message to the source node is after the switching succeeds. A sensing switching mode corresponding to this manner may be referred to as a soft switching mode.

For the foregoing hard switching mode, the source node may end the first sensing of poor reliability as soon as possible, so that a power loss caused by an unnecessary sensing operation performed by the source node can be avoided. For the soft switching mode, continuity of sensing the sensing target can be better maintained.

In some embodiments, the first device is the same as the source node, and the method further includes:
stopping, by the first device, performing sensing measurement on the sensing target in the first sensing manner.

Correspondingly, there may be a plurality of options for an occasion on which the first device stops performing sensing measurement on the sensing target in the first sensing manner. For example, once determining the target node, the first device may send the second notification message to the source node without considering whether the sensing switching succeeds. A sensing switching mode corresponding to this manner may be referred to as a hard switching mode.

In some embodiments, the stopping, by the first device, performing sensing measurement on the sensing target in the first sensing manner includes:
stopping, by the first device, performing sensing measurement on the sensing target in the first sensing manner in a case that a fourth notification message is received, where the fourth notification message is used to indicate that the target node performs at least one sensing measurement on the sensing target in the second sensing manner and obtains at least one measurement value of a sensing measurement quantity or at least one sensing result.

The fourth notification message may also be referred to as a switching success message, and is used to indicate that the target node successfully performs sensing measurement on the sensing target in the second sensing manner, for example, the at least one sensing measurement, and obtains the at least one measurement value of the sensing measurement quantity or the at least one sensing result.

In this implementation, an occasion on which the first device stops performing sensing measurement on the sensing target in the first sensing manner is after the switching succeeds. A sensing switching mode corresponding to this manner may be referred to as a soft switching mode.

It should be noted that the first request message may further include a soft switching request, and if the target candidate node agrees to and supports soft switching, the first parameter configuration information may further include soft switching parameter configuration information. The soft switching parameter configuration information may be understood as sensing parameter configuration information for which the target node performs sensing measurement on the sensing target in a case that a soft switching mode is used.

In addition, if the target node agrees to and supports soft switching, the target node may also add soft switching parameter configuration information to the second parameter configuration information.

In some embodiments, after the determining, by the first device, M target nodes from the target candidate node based on the feedback message, the method further includes:
sending, by the first device, a fifth notification message to a target candidate node other than the target node in the target candidate nodes, where the fifth notification message is used to instruct to cancel sensing measurement on the sensing target after the fifth notification message is received.

Considering that after the target node is determined, target candidate nodes other than the target node do not need to perform sensing operations on the sensing target, the fifth notification message instructs these target candidate nodes to cancel sensing measurement on the sensing target, so that a power loss caused by unnecessary sensing operations performed on these target candidate nodes can be avoided.

Sensing manner switching is performed in a mobile communication network, which includes two cases: the first sensing manner is switched to the second sensing manner and the second sensing manner is switched to the first sensing manner. FIG. 2a shows a case that the first sensing manner is switched to the second sensing manner, and FIG. 2b shows a case that the second sensing manner is switched to the first sensing manner. Considering that a sensing node in the network may change before and after the switching and the sensing node after the switching may be a network side device or UE, there are six combinations of each of the foregoing two switching cases. FIG. 2c shows six combinations of each of the foregoing two switching cases, where the network side device is a base station. To indicate that the sensing node may be a different device, a base station A, a base station B, a base station C, UE A, UE B, and UE C are used for differentiation. In FIG. 2c, a core network node may be a sensing function network element that has a sensing network function in a core network.

In this embodiment of this application, the first sensing manner is switched to the second sensing manner. Based on different types of sensing nodes, switching from the first sensing manner to the second sensing manner may include the following six switching scenarios:

Switching scenario 1: First sensing of a network side device (“base station first sensing” for short) is switched to second sensing of a network side device-a terminal (“base station-UE second sensing” for short).

Switching scenario 2: First sensing of a network side device is switched to second sensing of a network side device-a network side device (“base station-base station second sensing” for short).

Switching scenario 3: First sensing of a terminal (“UE first sensing” for short) is switched to second sensing of a network side device-a terminal.

Switching scenario 4: First sensing of a terminal is switched to second sensing of a terminal-a terminal (“UE-UE second sensing” for short).

Switching scenario 5: First sensing of a network side device is switched to second sensing of a terminal-a terminal.

Switching scenario 6: First sensing of a terminal is switched to second sensing of a network side device-a network side device.

To better understand this application, the following provides detailed descriptions based on different switching scenarios.

Switching scenario 1: Base station first sensing is switched to base station-UE second sensing. In some embodiments, the following procedures are included.

Step 11: A network side device performs switching measurement.

A core network node (for example, a sensing function network element) sends a switching measurement request to a source base station (that is, a network side device that performs first sensing), and after receiving the switching measurement request, the source base station performs switching measurement, and feeds back a switching measurement report to the core network node.

In some embodiments, a source base station actively performs switching measurement to obtain a switching measurement report. In some embodiments, the source base station sends the switching measurement report to a core network node.

In some embodiments, before the source base station performs switching measurement, the core network node may send, to the source base station, switching measurement configuration information required for the switching measurement, or the switching measurement configuration information is included in the switching measurement request. For the switching measurement configuration information, refer to the foregoing descriptions. Details are not described herein again.

In some embodiments, step 11 may be triggered based on a target event. For content of the target event, refer to the foregoing descriptions. Details are not described herein again.

Step 12: The source base station determines, based on the switching measurement report, whether to initiate the switching; or the core network node determines, based on the switching measurement report obtained from the source base station, whether to initiate a switching request.

If the switching is not initiated, subsequent processing may be maintaining or ending the current first sensing.

In some embodiments, if the switching is initiated, the core network node or the source base station determines which node is to be switched to the second sensing manner, which includes one of the following cases:

Case 1: The source base station determines to switch to the base station-UE second sensing.

The source base station sends first request information to at least one candidate target base station, where the first request information requests the receiver of the first request information to perform the base station-UE second sensing after the switching of the sensing manner is completed.

The candidate target base station sends second request information to at least one candidate target UE, where the second request information requests the receiver of the second request information to perform the base station-UE second sensing after the switching of the sensing manner is completed.

In some embodiments, the source base station sends first indication information to the core network node, and the first indication information notifies the receiver of the first indication information to perform the base station-UE second sensing after the sensing manner is switched.

Case 2: The core network node determines to switch to the base station-UE second sensing.

The core network node sends first request information to at least one candidate target base station.

The candidate target base station sends second request information to at least one candidate target UE.

In some embodiments, the core network node sends first indication information to the source base station.

In some embodiments, the candidate target base station includes the source base station.

Case 3: The source base station determines to actively switch to the base station-UE second sensing. In this case, the source base station is a candidate target base station.

The source base station sends second request information to at least one candidate target UE.

In some embodiments, the source base station sends second indication information to the core network node, where the second indication information indicates the receiver of the second indication information that the sender of the second indication information performs the second sensing after the switching of the sensing manner is completed.

In some embodiments, the case 3 further includes the case 1, and the at least one candidate target base station in the case 1 is a candidate target base station other than the source base station.

In some embodiments, the source base station or the core network node adds recommended third parameter configuration information to the first request information and/or the second request information. The third parameter configuration information is used by at least one of a candidate target base station, candidate target UE, a target base station, and target UE to perform a sensing parameter configuration for the second sensing.

If the first request information and the second request information include a soft switching request, for example, the third parameter configuration information includes parameter configuration information corresponding to soft switching.

The candidate target base station may be determined based on at least one of the following information:
(1) location information of the base station;
(2) antenna panel orientation information of the base station;
(3) sensing capability information of the base station (including at least one of a sensing coverage area of the base station, a maximum bandwidth available for sensing, maximum duration of a sensing service, a supported sensing signal type and frame format, and antenna array information of the base station (for example, an array type, an antenna quantity, an array aperture, an antenna polarization characteristic, an array element gain, and a directional characteristic));
(4) information about resources that may be currently used by the base station for sensing (including at least one of a time resource (a quantity of symbols, a quantity of slots, a quantity of frames, or the like), a frequency resource (a quantity of RBs, a quantity of REs, a total bandwidth, a location of an available band, or the like), an antenna resource (a quantity of antennas/a quantity of antenna subarrays), a phase modulation resource (a quantity of hardware phase shifters), and an orthogonal code resource (a length of an orthogonal code and a quantity of orthogonal codes)); and
(5) channel state information of the base station (including at least one of a channel transmission function/channel impulse response, a CQI, a PMI, a CSI-RS resource indicator, an SSB resource indicator, an LI, an RI, and an L1-RSRP of at least one communication link).

The candidate target UE may be determined based on at least one of the following information:
(1) location information of the UE;
(2) antenna panel orientation information of the UE;
(3) state information of the UE (including information such as a moving speed, a moving direction, and a time period of keeping still/moving);
(4) sensing capability information of the UE (including at least one of a sensing coverage area of the UE, a maximum bandwidth available for sensing, maximum duration of a sensing service, a supported sensing signal type and frame format, and antenna array information of the UE (an array type, an antenna quantity, an array aperture, an antenna polarization characteristic, an array element gain, and a directional characteristic));
(5) information about resources that may be currently used by the UE for sensing (including at least one of a time resource (a quantity of symbols, a quantity of slots, a quantity of frames, or the like), a frequency resource (a quantity of RBs, a quantity of REs, a total bandwidth, a location of an available band, or the like), an antenna resource (a quantity of antennas/a quantity of antenna subarrays), a phase modulation resource (a quantity of hardware phase shifters), and an orthogonal code resource (a length of an orthogonal code and a quantity of orthogonal codes)); and
(6) channel state information of the UE (including at least one of a channel transmission function/channel impulse response, a CQI, a PMI, a CSI-RS resource indicator, an SSB resource indicator, an LI, an RI, and an L1-RSRP of at least one communication link).

The first request information further includes at least one of the following information:
(1) a sensing requirement (indicating an area/object type of a sensing target, a required sensing function, a sensing purpose, and a sensing result);
(2) sensing QoS (including at least one of the following: a sensing resolution (which may be further divided into a ranging resolution, an angular resolution, a velocity resolution, an imaging resolution, and the like), sensing accuracy (which may be further divided into ranging accuracy, angular accuracy, velocity accuracy, positioning accuracy, and the like), a sensing range (which may further be divided into a ranging range, a velocity range, an angular range, an imaging range, and the like), a sensing delay (a time interval between sending of a sensing signal and obtaining of a sensing result or a time interval from initiation of a sensing requirement to obtaining of a sensing result), a sensing update rate (a time interval between two consecutive executions of sensing and obtaining of sensing results), a detection probability (a probability of correctly detecting presence of a sensing object), a false alarm probability (a probability of falsely detecting a sensing target in the absence of a sensing object), sensing security, and sensing privacy);
(3) a sensing measurement quantity;
(4) a sensing measurement result (including a sensing result directly or indirectly obtained based on at least one sensing measurement quantity);
(5) a sensing condition (including at least one of a sensing start time, a sensing end time, and sensing duration);
(6) prior information of a sensing target or a sensing area (including at least one of a type of the sensing target, an approximate location/area in which the sensing target is located, and a historical state (a speed, an angle, a distance, an acceleration, or a spatial orientation) of the sensing target); and
(7) a condition for determining that the sensing manner is successfully switched (for example, indicating a preset threshold that is to be reached by at least one sensing measurement quantity and/or a measurement result of a communication measurement quantity within a preset time period/for a preset quantity of times).

The second request information further includes at least one of the following information same as the first request information.

Step 13: The candidate target base station and the candidate target UE determine whether to accept to perform the first sensing after the sensing manner is switched. There are the following two cases:

Case 1: The candidate target base station and the candidate target UE agree with the switching. The following procedures are performed in sequence:

(13-1) The candidate target UE sends second acknowledgement information to the sender (the candidate target base station or the source base station) of the second request information, where the second acknowledgement information indicates the sender of the second request information that the sender of the second acknowledgement information agrees to perform the first sensing after the switching of the sensing manner is completed.

(13-2) After receiving the second acknowledgement information sent by the candidate target UE, the candidate target base station sends first acknowledgement information to the sender (the source base station or the core network node) of the first request information, where the first acknowledgement information indicates the sender of the first request information that the sender of the first acknowledgement information agrees to perform the first sensing after the switching of the sensing manner is completed.

In some embodiments, content of the first acknowledgement information includes content of the second acknowledgement information.

In some embodiments, the candidate target base station feeds back recommended first parameter configuration information in the first acknowledgement information. The first parameter configuration information may be understood as sensing parameter configuration information recommended by the candidate target base station, and is used by the candidate target sensing node to perform a sensing parameter configuration for the first sensing. The first parameter configuration information may be used to configure at least one of the following:
a waveform type, for example, at least one of OFDM, SC-FDMA, an OTFS, an FMCW, and a pulse signal;
a subcarrier spacing, for example, a subcarrier spacing of an OFDM system, for example, 30 KHz;
a guard interval, for example, a time interval between a moment at which sending of a signal ends and a moment at which a latest echo signal of the signal is received, where this parameter is proportional to a maximum sensing distance, for example, may be obtained by 2dₘₐₓ/c through calculation, where dₘₐₓ represents a maximum sensing distance (belonging to a sensing requirement), and for a self-transmitting and self-receiving sensing signal, dₘₐₓ represents a maximum distance between a receiving point of a sensing signal and a transmission point of the signal, and in some cases, a CP of an OFDM signal may be used to indicate a minimum guard interval;
a bandwidth, where this parameter is inversely proportional to a distance resolution and may be obtained by c/(2Δd), where Δd represents the distance resolution (belonging to a sensing requirement), and c represents a speed of light;
burst duration, where this parameter is inversely proportional to a rate resolution (belonging to a sensing requirement), and this parameter is a time span of a sensing signal and is mainly used to calculate a Doppler offset, and this parameter may be obtained by c/(2f_{c}Δv) through calculation, where Δv represents the rate resolution, and f_{c} represents a carrier frequency of the sensing signal;
a time domain interval, where this parameter may be obtained by c/(2f_{c}v_{range}) through calculation, where v_{range} represents a maximum velocity minus a minimum velocity (belonging to a sensing requirement), and this parameter is a time interval between two adjacent sensing signals;
a transmit signal power, for example, a value taken every 2 dBm from −20 dBm to 23 dBm;
a signal format, for example, information such as an SRS, a DMRS, a PRS, or another predefined signal and a related sequence format;
a signal direction, for example, a direction or beam information of a sensing signal;
a time resource, for example, an index of a slot in which a sensing signal is located or a symbol index of the slot, where the time resource is divided into two types, one is a one-time time resource, for example, a symbol sends an omnidirectional sensing signal, and the other is non-one-time time resources, for example, a plurality of groups of periodic time resources or discontinuous time resources (which may include a start time and an end time), each group of periodic time resources send sensing signals in a same direction, and beam directions on different groups of periodic time resources are different;
a frequency resource, including a center frequency, a bandwidth, an RB or a subcarrier, a reference point A, a start bandwidth location, and the like of a sensing signal;
a QCL relationship, for example, a sensing signal includes a plurality of resources, each resource corresponds to one SSB QCL, and the QCL includes Type A, Type B, Type C, or Type D; and
antenna configuration information.

In some embodiments, the candidate target UE feeds back recommended second parameter configuration information in the second acknowledgement information. The second parameter configuration information is used by the candidate target sensing node to perform a sensing parameter configuration for the first sensing.

In some embodiments, content of the first parameter configuration information includes content of the second parameter configuration information.

If the first request information includes a soft switching request and the candidate target base station agrees to and supports soft switching, for example, the first parameter configuration information includes soft switching parameter configuration information.

If the second request information includes a soft switching request and the candidate target UE agrees to and supports soft switching, for example, the second parameter configuration information includes soft switching parameter configuration information.

Case 2: At least one of the candidate target base station and the candidate target UE does not agree with the switching.

In some embodiments, the candidate target base station sends first rejection information to the sender (the source base station or the core network node) of the first request information, where the first rejection information indicates the sender of the first request information that the sender of the first rejection information does not perform the first sensing.

In some embodiments, the candidate target UE sends second rejection information to sender (the candidate target base station or the source base station) of the second request information, where the second rejection information indicates the sender of the second request information that the sender of the second rejection information does not perform the first sensing.

Subsequent processing may be one of the following: the source base station re-determines candidate target UE; the candidate target base station re-determines candidate target UE; the source base station or the core network node re-determines a candidate target base station, and the candidate target base station re-determines candidate target UE; cancelling the switching and maintaining the current second sensing; and ending the current second sensing.

Step 14: The source base station or the core network node determines a sensing node that performs the first sensing. There are the following two cases:

Case 1: The source base station or the core network node determines the target base station, and the target base station determines the target UE.

The source base station or the core network node determines, based on the received first acknowledgement information, at least one target base station from the candidate target base station as a sensing node that performs the first sensing after the switching.

The source base station or the core network node sends a switching command to the target base station. The switching command is used to instruct the target sensing node to perform the first sensing operation.

After receiving the switching command, the target base station determines at least one target UE from the candidate target UE as a sensing node that performs the first sensing after the switching. Further, the target base station sends the switching command to the target UE.

Case 2: The source base station or the core network node simultaneously determines the target base station and the target UE.

The source base station or the core network node determines, based on the received first acknowledgement information, at least one target base station from the candidate target base station and at least one target UE as sensing nodes that perform the first sensing after the switching.

The source base station or the core network node sends a switching command to the target base station, and the target base station sends the switching command to the target UE.

In some embodiments, the source base station or the core network node feeds back recommended third parameter configuration information in the switching command. The third parameter configuration information is used by the target sensing node to perform a sensing parameter configuration for the first sensing.

The third parameter configuration information includes at least one of the following: being the same as the first parameter configuration information.

In some embodiments, the third parameter configuration information includes soft switching parameter configuration information.

Step 15: The target base station and the target UE perform the first sensing. In some embodiments, the following two operations are performed:

Operation 1: A soft switching method is adopted. The target base station and the target UE perform a sensing parameter configuration based on at least one of the first request information, the first parameter configuration information, the second parameter configuration information, and the third parameter configuration information, to perform the first sensing.

After the target base station or the target UE obtains at least one measurement value of a sensing measurement quantity and/or a sensing result, the target base station sends a switching success message to the source base station or the core network node.

Further, one of the following several cases is included:

(1) The sender of the first request information is the source base station, and the source base station and the target base station are not a same device.

After receiving the switching success message, the source base station ends the original sensing operation, and releases resources occupied for the sensing (including a time-frequency resource, an antenna port resource, and the like).

(2) The sender of the first request information is the core network node, and the source base station and the target base station are not a same device.

After the core network node receives the switching success message, the core network node sends a first end command to the source base station. The source base station ends the original sensing operation, and releases resources occupied for the sensing (including a time-frequency resource, an antenna port resource, and the like).

(3) The sender of the first request information is the core network node, and the source base station and the target base station are a same device.

After receiving the switching success message, the core network node sends a second end command to the source base station. The source base station ends the original sensing operation.

(4) The source base station actively serves as the target base station.

After the switching succeeds, the source base station actively ends the original sensing operation.

Operation 2: A hard switching method is adopted. When step 14 is performed, the source base station or the core network node does not need to wait for a switching success message. One of the following several cases is included:

(1) The sender of the first request information is the source base station, and the source base station and the target base station are not a same device.

The source base station ends the original sensing operation, and releases resources occupied for the sensing (including a time-frequency resource, an antenna port resource, and the like).

(2) The sender of the first request information is the core network node, and the source base station and the target base station are not a same device.

The core network node sends a first end command to the source base station. The source base station ends the original sensing operation, and releases resources occupied for the sensing (including a time-frequency resource, an antenna port resource, and the like).

(3) The sender of the first request information is the core network node, and the source base station and the target base station are a same device.

The source base station actively ends the original sensing operation.

(4) The source base station actively serves as the target base station.

The source base station actively ends the original sensing operation.

In some embodiments, the source base station or the core network node sends historical measurement values of a part or all of sensing measurement quantities and/or historical sensing results and prior information of a sensing target/area to the target UE. Herein, a sensing measurement quantity before the sensing manner is switched may be the same as or different from a sensing measurement quantity after the sensing manner is switched.

Switching scenario 2: Base station first sensing is switched to base station-base station second sensing. In some embodiments, the following procedures are included.

Step 21 is the same as step 11, and details are not described herein again.

Step 22: The source base station determines, based on the switching measurement report, whether to initiate the switching.

In some embodiments, the core network node determines, based on the switching measurement report obtained from the source base station, whether to initiate a switching request.

If the switching is not initiated, subsequent processing may be maintaining or ending the current first sensing.

In some embodiments, if the switching is initiated, the core network node or the source base station determines which node is to be switched to the first sensing manner, which includes one of the following cases:

Case 1: The source base station determines to switch to the base station-base station first sensing.

The source base station sends third request information to at least two candidate target base stations, where the third request information requests the receiver of the third request information to perform the base station-base station first sensing after the switching of the sensing manner is completed.

In some embodiments, the source base station sends third indication information to the core network node, where the third indication information notifies the receiver of the third indication information to perform the base station-base station first sensing after the sensing manner is switched.

Case 2: The core network node determines to switch to the base station-base station first sensing.

The core network node sends third request information to at least two candidate target base stations.

In some embodiments, the core network node sends third indication information to the source base station.

The candidate target base station includes the source base station.

Case 3: The source base station determines to actively switch to the base station-base station first sensing. In this case, the source base station is a candidate target base station.

The source base station sends third request information to at least one candidate target base station.

In some embodiments, the source base station sends second indication information to the core network node, where the second indication information indicates the receiver of the second indication information that the sender of the second indication information performs the first sensing after the switching of the sensing manner is completed.

In some embodiments, the third request information may include a soft switching request.

The third request information further includes at least one of the following information the same as the first request information.

Step 23: The candidate target base station determines whether to accept to perform the first sensing after the sensing manner is switched. There are the following two cases:

Case 1: The candidate target base station agrees with the switching.

The candidate target base station sends first acknowledgement information to the sender of the first request information (the source base station or the core network node).

In some embodiments, the candidate target base station feeds back recommended first parameter configuration information in the first acknowledgement information.

If the first request information includes a soft switching request and the candidate target base station agrees to and supports soft switching, for example, the first parameter configuration information includes soft switching parameter configuration information.

Case 2: The candidate target base station does not agree with the switching.

In some embodiments, the candidate target base station sends first rejection information to the sender of the first request information (the source base station or the core network node).

Subsequent processing may be one of the following: the source base station or the core network node re-determines a candidate target base station; cancelling the switching and maintaining the current second sensing; and ending the current second sensing.

Step 24: The source base station or the core network node determines a sensing node that performs the first sensing.

The source base station or the core network node determines, based on the received first acknowledgement information, at least two target base stations (a base station A and a base station B) from candidate target base stations as sensing nodes that perform the first sensing after the switching.

The source base station or the core network node sends a switching command to the target base station.

The target base station includes the source base station.

In some embodiments, the source base station or the core network node feeds back recommended third parameter configuration information in the switching command.

The third parameter configuration information includes at least one of the following: being the same as the first parameter configuration information.

In some embodiments, the third parameter configuration information includes soft switching parameter configuration information.

Step 25: The target base stations (the base station A and the base station B) perform the first sensing. In some embodiments, subsequent processing includes the following two cases:

Case 1: A soft switching method is adopted. The target base stations (the base station A and the base station B) perform a sensing parameter configuration based on at least one of the first request information, the first parameter configuration information, the second parameter configuration information, and the third parameter configuration information, to perform the first sensing.

After the target base station obtains at least one measurement value of a sensing measurement quantity and/or a sensing result, the target base station sends a switching success message to the source base station or the core network node.

Further, one of the following several cases is included:

(1) The sender of the third request information is the source base station, and the source base station and the target base station are not a same device.

After receiving the switching success message, the source base station ends the original sensing operation, and releases resources occupied for the sensing (including a time-frequency resource, an antenna port resource, and the like).

(2) The sender of the third request information is the core network node, and the source base station and the target base station are not a same device.

After the core network node receives the switching success message, the core network node sends a first end command to the source base station. After receiving the first end command, the source base station ends the original sensing operation, and releases resources occupied for the sensing (including a time-frequency resource, an antenna port resource, and the like).

(3) The sender of the third request information is the core network node, and the source base station and the target base station are a same device.

After receiving the switching success message, the core network node sends a second end command to the source base station. The source base station ends the original sensing operation.

(4) The source base station actively serves as the target base station (the base station A or the base station B).

After the switching succeeds, the source base station actively ends the original sensing operation.

Case 2: A hard switching method is adopted. When step 24 is performed, the source base station or the core network node does not need to wait for a switching success message. One of the following several cases is included:

(1) The sender of the third request information is the source base station, and the source base station and the target base station are not a same device.

The source base station ends the original sensing operation, and releases resources occupied for the sensing (including a time-frequency resource, an antenna port resource, and the like).

(2) The sender of the third request information is the core network node, and the source base station and the target base station are not a same device.

The core network node sends a first end command to the source base station. The source base station ends the original sensing operation, and releases resources occupied for the sensing (including a time-frequency resource, an antenna port resource, and the like).

(3) The sender of the third request information is the core network node, and the source base station and the target base station are a same device.

The source base station actively ends the original sensing operation.

(4) The source base station actively serves as the target base station.

The source base station actively ends the original sensing operation.

In some embodiments, the source base station or the core network node sends historical measurement values of a part or all of sensing measurement quantities and/or historical sensing results and prior information of a sensing target/area to the target base station.

Switching scenario 3: UE first sensing is switched to base station-UE second sensing. In some embodiments, the following procedures are included.

Step 31: A network side device performs switching measurement.

A source terminal actively initiates switching measurement to obtain a switching measurement report. In some embodiments, the source terminal sends the switching measurement report to a source access base station (that is, an access base station of the source terminal) and/or a core network node.

In some embodiments, a source access base station sends a switching measurement request to a source terminal, and after receiving the switching measurement request, the source terminal performs switching measurement, and feeds back a switching measurement report to the source access base station. In some embodiments, the source access base station sends the switching measurement report to a core network node.

In some embodiments, a core network node (for example, a sensing function network element) sends a switching measurement request to a source terminal, and after receiving the switching measurement request, the source terminal performs switching measurement, and feeds back a switching measurement report to the core network node. In some embodiments, the core network node sends the switching measurement report to a source access base station.

In some embodiments, before the source terminal performs the switching measurement, the source access base station or the core network node sends switching measurement configuration information required for the switching measurement to the source terminal. In some embodiments, the switching measurement configuration information is included in the switching measurement request.

For content included in the switching measurement configuration information, refer to the foregoing embodiment. Details are not described herein again.

In some embodiments, step 31 may be triggered based on a target event. For content of the target event, refer to the foregoing embodiment. Details are not described herein again.

Step 32: The source access base station or the core network node determines, based on the switching measurement report, whether to initiate the switching.

If the switching is not initiated, subsequent processing may be maintaining or ending the current first sensing (that is, a sensing operation performed in the first sensing manner).

In some embodiments, if the switching is initiated, any one of the core network node, the source access base station, and the source UE determines is to be switched to the first sensing manner, which includes the following cases:

Case 1: The source access base station determines to switch to the base station-UE second sensing.

The source access base station sends first request information to at least one candidate target base station.

The candidate target base station sends second request information to at least one candidate target UE.

In some embodiments, the source access base station sends first indication information to the core network node.

Case 2: The core network node determines to switch to the base station-UE second sensing.

The core network node sends first request information to at least one candidate target base station.

The candidate target base station sends second request information to at least one candidate target UE.

In some embodiments, the core network node sends first indication information to the source access base station.

The candidate target base station includes the source access base station.

Case 3: The source UE determines to actively switch to the base station-UE first sensing. In this case, the source UE is candidate target UE.

The source UE sends second indication information to the source access base station and/or the core network node.

The source access base station or the core network node sends first request information to at least one candidate target base station.

The candidate target base station sends second request information to at least one candidate target UE including the source UE.

The candidate target base station includes the source access base station.

In some embodiments, the source access base station or the core network node adds recommended third parameter configuration information to the first request information and/or the second request information. For specific content of the third parameter configuration information, refer to the foregoing embodiment. Details are not described herein again.

Step 33: The candidate target base station and the candidate target UE determine whether to accept to perform the first sensing after the sensing manner is switched. There are the following two cases:

Case 1: The candidate target base station and the candidate target UE agree with the switching. The following procedures are performed in sequence:

(33-1) The candidate target base station and the candidate target UE perform a sensing parameter configuration based on at least one of the first request information, the second request information, and the third parameter configuration information, to perform the second sensing.

(33-2) After the sensing measurement is performed at least once, the candidate target base station sends first acknowledgement information to the source access base station or the core network node. For content of the first acknowledgement message, refer to the foregoing embodiment. Details are not described herein again.

(33-3) The source access base station or the core network node waits for the first acknowledgement information of the candidate target base station within a preset time period, and once the first acknowledgement information sent by the candidate target base station is received and meets a target switching condition, immediately selects, as sensing nodes that perform the second sensing after the switching, the candidate target base station and candidate target UE that performs the second sensing together with the candidate target base station. The candidate target UE that jointly performs the second sensing is UE that sends second acknowledgement information meeting the target switching condition.

Case 2: At least one of the candidate target base station and the candidate target UE does not agree with the switching.

In some embodiments, the candidate target base station sends first rejection information to the sender (the source base station or the core network node) of the first request information, where the first rejection information indicates the sender of the first indication information that the sender of the first rejection information does not perform the second sensing.

In some embodiments, the candidate target UE sends second rejection information to the sender (the source base station or the candidate target base station) of the second request information, where the second rejection information indicates the sender of the second indication information that the sender of the second rejection information does not perform the second sensing.

If no candidate target base station or candidate target UE agrees to perform the second sensing within the preset waiting time period, subsequent processing may be one of the following: the source base station re-determines candidate target UE; the candidate target base station re-determines candidate target UE; the source base station or the core network node re-determines a candidate target base station, and the candidate target base station re-determines candidate target UE; cancelling the switching and maintaining the current first sensing; and ending the current first sensing.

Step 34: The source base station or the core network node determines a sensing node that performs the first sensing. There are the following two cases:

Case 1: The source base station or the core network node determines the target base station, and the target base station determines the target UE.

The source base station or the core network node determines, based on the received first acknowledgement information, at least one target base station from the candidate target base station as a sensing node that performs the first sensing after the switching.

The source base station or the core network node sends a switching command to the target base station.

After receiving the switching command, the target base station determines at least one target UE from the candidate target UE as a sensing node that performs the first sensing after the switching. Further, the target base station sends the switching command to the target UE.

Case 2: The source base station or the core network node simultaneously determines the target base station and the target UE.

The source base station or the core network node determines, based on the received first acknowledgement information, at least one target base station from the candidate target base station and at least one target UE as sensing nodes that perform the first sensing after the switching.

The source base station or the core network node sends a switching command to the target base station, and the target base station sends the switching command to the target UE.

In some embodiments, the source base station or the core network node feeds back recommended third parameter configuration information in the switching command.

The third parameter configuration information includes at least one of the following: being the same as the first parameter configuration information.

In some embodiments, the third parameter configuration information includes soft switching parameter configuration information.

Step 35: The target base station and the target UE perform the first sensing. In some embodiments, subsequent processing includes the following two cases:

Case 1: A soft switching method is adopted. The target base station and the target UE perform a sensing parameter configuration based on at least one of the first request information, the first parameter configuration information, the second parameter configuration information, and the third parameter configuration information, to perform the first sensing.

After the target base station or the target UE obtains at least one measurement value of a sensing measurement quantity and/or a sensing result, the target base station sends a switching success message to the source access base station or the core network node.

Further, one of the following several cases is included:

(1) The sender of the first request information is the source access base station or the core network node, and the source UE and the target UE are not a same device.

After receiving the switching success message, the source access base station or the core network node sends a first end command to the source UE. The source UE ends the original sensing operation, and releases resources occupied for the sensing (including a time-frequency resource, an antenna port resource, and the like).

(2) The sender of the first request information is the source access base station or the core network node, and the source UE and the target UE are a same device.

After receiving the switching success message, the source access base station or the core network node sends a second end command to the source UE. The source UE ends the original sensing operation.

(3) The source UE actively serves as the target UE.

After the switching succeeds, the source UE actively ends the original sensing operation.

Case 2: A hard switching method is adopted. When step 34 is performed, the source base station or the core network node does not need to wait for a switching success message. One of the following several cases is included:

(1) The sender of the first request information is the source access base station or the core network node, and the source UE and the target UE are not a same device.

The source access base station or the core network node sends a first end command to the source UE. The source UE ends the original sensing operation, and releases resources occupied for the sensing (including a time-frequency resource, an antenna port resource, and the like).

(2) The sender of the first request information is the source access base station or the core network node, and the source UE and the target UE are a same device.

The source access base station or the core network node sends a second end command to the source UE. The source UE ends the original sensing operation.

(3) The source UE actively serves as the target UE.

The source UE actively ends the original sensing operation.

In some embodiments, the source UE, the source access base station, or the core network node sends historical measurement values of a part or all of sensing measurement quantities and/or historical sensing results and prior information of a sensing target/area to the target UE.

Switching scenario 4: UE first sensing is switched to UE-UE second sensing. In some embodiments, the following procedures are included.

Step 41 is the same as step 31, and details are not described herein again.

Step 42: The source access base station or the core network node determines, based on the switching measurement report, whether to initiate the switching.

If the switching is not initiated, subsequent processing may be maintaining or ending the current first sensing (that is, a sensing operation performed in the first sensing manner).

In some embodiments, if the switching is initiated, any one of the core network node, the source access base station, and the source UE determines is to be switched to the first sensing manner, which includes one of the following cases:

Case 1: The source access base station determines to switch to the UE-UE second sensing. At least one of the following methods may be adopted.

(1) The source access base station sends a request message A to at least one candidate target access base station (that is, an access base station of the candidate target UE), where the request message A requests the receiver of the request message A to perform the UE-UE second sensing after the switching of the sensing manner is completed. The candidate target access base station sends second request information to at least two candidate target UEs, where the second request information requests the receiver of the second request information to perform the UE-UE second sensing after the switching of the sensing manner is completed.

(2) The source access base station sends the second request information to the at least two candidate target UEs.

In some embodiments, the source access base station sends first indication information to the core network node, where the first indication information notifies the receiver of the first indication information to perform the UE-UE second sensing after the sensing manner is switched.

Case 2: The core network node determines to switch to the UE-UE second sensing.

The core network node sends first request information to at least one candidate target access base station.

The candidate target access base station sends second request information to at least one candidate target UE.

In some embodiments, the core network node sends first indication information to the source access base station.

The candidate target access base station includes the source access base station.

Case 3: The source UE determines to actively switch to the UE-UE second sensing. In this case, the source UE is candidate target UE.

The source UE sends second indication information to the source access base station and/or the core network node.

The source access base station or the core network node sends first request information to at least one candidate target access base station.

The candidate target access base station sends second request information to at least two candidate target UEs including the source UE.

The candidate target access base station includes the source access base station.

In some embodiments, the source access base station or the core network node adds recommended third parameter configuration information to the first request information and/or the second request information. For specific content of the third parameter configuration information, refer to the foregoing embodiment. Details are not described herein again.

Step 43: The candidate target UE determine whether to accept to perform the first sensing after the sensing manner is switched. There are the following two cases:

Case 1: The candidate target UE agrees with the switching. The following procedures are performed in sequence:

(43-1) The candidate target UE performs a sensing parameter configuration based on at least one of the first request information and the third parameter configuration information, to perform the second sensing.

(43-2) After the sensing measurement is performed at least once, the candidate target UE sends first acknowledgement information to the source access base station or the core network node. For example, the candidate target UE may send the first acknowledgement information to the candidate target access base station, and the candidate target access base station forwards the first acknowledgement information to the source access base station or the core network node.

(43-3) The source access base station or the core network node waits for the first acknowledgement information of the candidate target access base station within a preset time period, and once the first acknowledgement information sent by the candidate target access base station is received and meets a target switching condition, immediately selects, as a sensing node that performs the first sensing after the switching, the candidate target UE that is accessed by the candidate target access base station and that is corresponding to the sent first acknowledgement information.

Case 2: The candidate target UE does not agree with the switching.

In some embodiments, the candidate target UE does not agree with the switching. In some embodiments, the candidate target UE sends first rejection information to the sender (the source access base station or the core network node) of the first request information. In some embodiments, the candidate target UE may send the first rejection information to the candidate target access base station, and the candidate target access base station forwards the first rejection information to the source access base station or the core network node.

If no candidate target UE agrees to perform the first sensing within the preset waiting time period, subsequent processing may be one of the following: the source access base station re-determines candidate target UE; the candidate target access base station re-determines candidate target UE; the source access base station or the core network node re-determines a candidate target access base station, and the candidate target access base station determines candidate target UE; cancelling the switching and maintaining the current second sensing; and ending the current second sensing.

Step 44: The source access base station or the core network node determines a sensing node that performs the first sensing.

The source access base station or the core network node determines, based on the received first acknowledgement information, at least two target UEs (UE A and UE B) from candidate target UEs as sensing nodes that perform the first sensing after the switching.

The source access base station or the core network node sends a switching command to the target UE.

The target UE includes the source UE.

In some embodiments, the source access base station or the core network node feeds back recommended third parameter configuration information in the switching command.

The third parameter configuration information includes at least one of the following: being the same as the first parameter configuration information.

In some embodiments, the third parameter configuration information includes soft switching parameter configuration information.

Step 45: The target UEs (the UE A and the UE B) perform the first sensing. In some embodiments, subsequent processing includes the following two cases:

Case 1: A soft switching method is adopted. The target UEs (the UE A and the UE B) perform a sensing parameter configuration based on at least one of the first request information, the first parameter configuration information, the second parameter configuration information, and the third parameter configuration information, to perform the first sensing.

After the target UE obtains at least one measurement value of a sensing measurement quantity and/or a sensing result, the target UE sends a switching success message to the source access base station or the core network node.

Further, one of the following several cases is included:

(1) The sender of the request information is the source access base station or the core network node, and the source UE and the target UE are not a same device.

After receiving the switching success message, the source access base station or the core network node sends a first end command to the source UE. The source UE ends the original sensing operation, and releases resources occupied for the sensing (including a time-frequency resource, an antenna port resource, and the like).

(2) The sender of the request information is the source access base station or the core network node, and the source UE and the target UE are a same device.

After receiving the switching success message, the source access base station or the core network node sends a second end command to the source UE. The source base station ends the original sensing operation.

(3) The source UE actively serves as the target UE (the UE A or the UE B).

After the switching succeeds, the source UE actively ends the original sensing operation.

Case 2: A hard switching method is adopted. When step 44 is performed, the source base station or the core network node does not need to wait for a switching success message. One of the following several cases is included:

(1) The sender of the request information is the source access base station or the core network node, and the source UE and the target UE are not a same device.

The source access base station or the core network node sends a first end command to the source UE. The source UE ends the original sensing operation, and releases resources occupied for the sensing (including a time-frequency resource, an antenna port resource, and the like).

(2) The sender of the request information is the source access base station or the core network node, and the source UE and the target UE are a same device.

The source access base station or the core network node sends a second end command to the source UE. The source base station ends the original sensing operation.

(4) The source UE actively serves as the target UE (the UE A or the UE B).

The source UE actively ends the original sensing operation.

In some embodiments, the source UE, the source access base station, or the core network node sends historical measurement values of a part or all of sensing measurement quantities and/or historical sensing results and prior information of a sensing target/area to the target UE.

Switching scenario 5: Base station first sensing is switched to UE-UE second sensing. In some embodiments, the following procedures are included.

Step 51 is the same as step 11, and details are not described herein again.

Step 52: The source base station or the core network node determines, based on the switching measurement report, whether to initiate the switching.

If the switching is not initiated, subsequent processing may be maintaining or ending the current first sensing.

In some embodiments, if the switching is initiated, the source base station or the core network node determines which node is to be switched to the first sensing manner, which includes one of the following cases:

Case 1: The source base station determines to switch to the UE-UE first sensing. At least one of the following methods may be adopted.

(1) The source base station sends fourth request information to at least one candidate target access base station. The candidate target access base station sends fifth request information to at least two candidate target UEs.

(2) The source base station sends fifth request information to at least two candidate target UEs. In this case, the source base station is a candidate target access base station.

In some embodiments, the source base station sends fourth indication information to the core network node.

Case 2: The core network node determines to switch to the UE-UE first sensing.

The core network node sends fourth request information to at least one candidate target access base station.

The candidate target base station sends fifth request information to at least one candidate target UE.

In some embodiments, the core network node sends fourth indication information to the source base station.

The candidate target access base station includes the source base station.

In some embodiments, the fourth request information and the fifth request information may include a soft switching request.

The candidate target base station is determined based on at least one of the following information: being the same as that in the switching scenario 1.

The candidate target UE is determined based on at least one of the following information: being the same as that in the switching scenario 1.

The fourth request information and the fifth request information further include at least one of the following information: being the same as the first request information in the switching scenario 1.

Step 53: The candidate target UE determines whether to accept to perform the first sensing after the sensing manner is switched. There are the following two cases:

Case 1: The candidate target UE agrees with the switching.

The candidate target UE sends first acknowledgement information to the source base station or the core network node. In some embodiments, the candidate target UE may send the first acknowledgement information to the candidate target access base station, and the candidate target access base station forwards the first acknowledgement information to the source base station or the core network node.

In some embodiments, the candidate target UE feeds back recommended first parameter configuration information in the first acknowledgement information.

The first parameter configuration information includes at least one of the following: being the same as that in the switching scenario 1.

If the first request information includes a soft switching request and the candidate target UE agrees to and supports soft switching, for example, the first parameter configuration information includes soft switching parameter configuration information.

Case 2: The candidate target UE does not agree with the switching.

In some embodiments, the candidate target UE sends first rejection information to the sender (the source base station or the core network node) of the first request information. In some embodiments, the candidate target UE may send the first rejection information to the candidate target access base station, and the candidate target access base station forwards the first rejection information to the source base station or the core network node.

Subsequent processing may be one of the following: the source base station re-determines candidate target UE; the candidate target access base station re-determines candidate target UE; the source base station or the core network node re-determines a candidate target access base station, and the candidate target access base station determines candidate target UE; cancelling the switching and maintaining the current second sensing; and ending the current second sensing.

Step 54: The source base station or the core network node determines a sensing node that performs the first sensing.

The source base station or the core network node determines, based on the received first acknowledgement information, at least two target UEs (UE A and UE B) from candidate target UEs as sensing nodes that perform the first sensing after the switching.

The source base station or the core network node sends a switching command to the target UE. In some embodiments, the source base station or the core network node may send the switching command to the target access base station, and the target access base station forwards the switching command to the target UE.

In some embodiments, the source base station or the core network node feeds back recommended third parameter configuration information in the switching command.

The third parameter configuration information includes at least one of the following: being the same as the first parameter configuration information.

In some embodiments, the third parameter configuration information includes soft switching parameter configuration information.

Step 55: The target UEs (the UE A and the UE B) perform the first sensing. In some embodiments, subsequent processing includes the following two cases:

Case 1: A soft switching method is adopted. The target UEs (the UE A and the UE B) perform a sensing parameter configuration based on at least one of the first request information, the first parameter configuration information, the second parameter configuration information, and the third parameter configuration information, to perform the first sensing.

After the target UE obtains at least one measurement value of a sensing measurement quantity and/or a sensing result, the target UE sends a switching success message to the source base station or the core network node.

Further, one of the following several cases is included:

(1) The sender of the request information is the source base station, and the source base station and the target access base station are not a same device.

After receiving the switching success message, the source base station ends the original sensing operation, and releases resources occupied for the sensing (including a time-frequency resource, an antenna port resource, and the like).

(2) The sender of the request information is the core network node, and the source base station and the target access base station are not a same device.

After receiving the switching success message, the core network node sends a first end command to the source base station. The source base station ends the original sensing operation, and releases resources occupied for the sensing (including a time-frequency resource, an antenna port resource, and the like).

(3) The sender of the request information is the source base station, and the source base station and the target access base station are a same device.

After receiving the switching success message, the source base station ends the original sensing operation.

(4) The sender of the request information is the core network node, and the source base station and the target access base station are a same device.

After receiving the switching success message, the core network node sends a second end command to the source base station. The source base station ends the original sensing operation.

Case 2: A hard switching method is adopted. When step 54 is performed, the source base station or the core network node does not need to wait for a switching success message. One of the following several cases is included:

(1) The sender of the request information is the source base station, and the source base station and the target access base station are not a same device.

The source base station ends the original sensing operation, and releases resources occupied for the sensing (including a time-frequency resource, an antenna port resource, and the like).

(2) The sender of the request information is the core network node, and the source base station and the target access base station are not a same device.

The core network node sends a first end command to the source base station. The source base station ends the original sensing operation, and releases resources occupied for the sensing (including a time-frequency resource, an antenna port resource, and the like).

(3) The sender of the request information is the source base station, and the source base station and the target access base station are a same device.

The source base station ends the original sensing operation.

(4) The sender of the request information is the core network node, and the source base station and the target access base station are a same device.

The core network node sends a second end command to the source base station. The source base station ends the original sensing operation.

In some embodiments, the source UE, the source base station, or the core network node sends historical measurement values of a part or all of sensing measurement quantities and/or historical sensing results and prior information of a sensing target/area to the target UE (the UE A and/or the UE B).

Switching scenario 6: UE first sensing is switched to base station-base station second sensing. In some embodiments, the following procedures are included.

Step 61 is the same as step 31, and details are not described herein again.

Step 62: The source access base station or the core network node determines, based on the switching measurement report, whether to initiate the switching.

If the switching is not initiated, subsequent processing may be maintaining or ending the current first sensing.

In some embodiments, if the switching is initiated, any one of the core network node, the source access base station, and the source UE determines is to be switched to the first sensing manner, which includes one of the following cases:

Case 1: The source access base station determines to switch to the base station-base station first sensing.

The source access base station sends third request information to at least two candidate target base stations.

In some embodiments, the source access base station sends third indication information to the core network node.

Case 2: The core network node determines to switch to the base station-base station first sensing.

The core network node sends third request information to at least two candidate target base stations.

In some embodiments, the core network node sends third indication information to the source access base station.

The candidate target base station includes the source access base station.

Case 3: The source access base station determines to actively switch to the base station-base station first sensing. In this case, the source access base station is a candidate target base station.

The source access base station sends second indication information to the core network node.

The source access base station or the core network node sends third request information to at least one candidate target base station.

In some embodiments, the third request information may include a soft switching request.

The candidate target base station is determined based on at least one of the following information: being the same as that in the switching scenario 1.

The third request information further includes at least one of the following information: being the same as the first request information in the switching scenario 1.

Step 63: The candidate target base station determines whether to accept to perform the first sensing after the sensing manner is switched. There are the following two cases:

Case 1: The candidate target base station agrees with the switching.

The candidate target base station sends first acknowledgement information to the sender (the source access base station or the core network node) of the first request information.

In some embodiments, the candidate target base station feeds back recommended first parameter configuration information in the first acknowledgement information.

The first parameter configuration information includes at least one of the following: being the same as that in the switching scenario 1.

If the first request information includes a soft switching request and the candidate target base station agrees to and supports soft switching, for example, the first parameter configuration information includes soft switching parameter configuration information.

Case 2: The candidate target base station does not agree with the switching.

In some embodiments, the candidate target base station sends first rejection information to the sender (the source access base station or the core network node) of the first request information.

Subsequent processing may be one of the following: the source access base station or the core network node re-determines a candidate target base station; maintaining the current first sensing; and ending the current first sensing.

Step 64: The source access base station or the core network node determines a sensing node that performs the first sensing.

The source access base station or the core network node determines, based on the received first acknowledgement information, at least two target base stations (a base station A and a base station B) from candidate target base stations as sensing nodes that perform the first sensing after the switching.

The source access base station or the core network node sends a switching command to the target base station.

The target base station includes the source access base station.

In some embodiments, the source access base station or the core network node feeds back recommended third parameter configuration information in the switching command.

The third parameter configuration information includes at least one of the following: being the same as the first parameter configuration information.

In some embodiments, the third parameter configuration information includes soft switching parameter configuration information.

Step 65: The target base stations (the base station A and the base station B) perform the first sensing. In some embodiments, subsequent processing includes the following two cases:

Case 1: A soft switching method is adopted. The target base stations (the base station A and the base station B) perform a sensing parameter configuration based on at least one of the first request information, the first parameter configuration information, the second parameter configuration information, and the third parameter configuration information, to perform the first sensing.

After the target base station obtains at least one measurement value of a sensing measurement quantity and/or a sensing result, the target base station sends a switching success message to the source access base station or the core network node.

After receiving the switching success message, the source access base station or the core network node sends a first end command to the source UE. The source UE ends the original sensing operation, and releases resources occupied for the sensing (including a time-frequency resource, an antenna port resource, and the like).

Case 2: A hard switching method is adopted. When step 64 is performed, the source access base station or the core network node does not need to wait for a switching success message.

The source access base station or the core network node sends a first end command to the source UE. The source UE ends the original sensing operation, and releases resources occupied for the sensing (including a time-frequency resource, an antenna port resource, and the like).

In some embodiments, the source UE, the source access base station, or the core network node sends measurement values of a part or all of historical sensing measurement quantities and/or historical sensing results and prior information of a sensing target/area to the target base station.

In conclusion, in a scenario in which a sensing node performs sensing measurement on the sensing target in the first sensing manner, switching of the sensing manner of the sensing target from the first sensing manner to the second sensing manner is initiated, so that the sensing measurement can be performed in a proper sensing manner, thereby improving reliability of the sensing measurement.

The sensing manner switching method provided in the embodiments of this application may be performed by a sensing manner switching apparatus. In the embodiments of this application, an example in which the sensing manner switching apparatus performs the sensing manner switching method is used to describe the sensing manner switching apparatus provided in the embodiments of this application.

Referring to FIG. 3, an embodiment of this application further provides a sensing manner switching apparatus, which may be applied to a first device. As shown in FIG. 3, the sensing manner switching apparatus 300 includes:
an obtaining module 301, configured to obtain a first measurement report, where the first measurement report is generated by a source node by performing first sensing measurement on a sensing target in a first sensing manner, a signal sending node in the first sensing manner and a signal receiving node in the first sensing manner are a same node, and the first device is the same as or different from the source node; and
a first determining module 302, configured to determine, based on the first measurement report, whether to initiate switching of a sensing manner of the sensing target from the first sensing manner to a second sensing manner, where a signal sending node in the second sensing manner and a signal receiving node in the second sensing manner are different nodes.

In some embodiments, the first device includes any one of the following:
in a case that the source node is a first network side device, the first device includes a core network node or the first network side device; and
in a case that the source node is a first terminal, the first device includes a core network node, the first terminal, or a second network side device accessed by the first terminal.

In some embodiments, the first device is different from the source node; and
the sensing manner switching apparatus 300 further includes:
a first sending module, configured to send a first measurement request to the source node, where the first measurement request is used to request the source node to perform the first sensing measurement on the sensing target in the first sensing manner; and
the obtaining module 301, for example, is configured to:
receive the first measurement report sent by the source node, where the first measurement report is generated by the source node based on the first sensing measurement.

In some embodiments, the first sending module is configured to:
send the first measurement request to the source node in a case that it is determined that a target event occurs, where
the target event includes at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a first preset threshold; and
a measurement value of a communication measurement quantity of the source node reaches a second preset threshold.

In some embodiments, the sensing manner switching apparatus 300 further includes:
a second sending module, configured to send first measurement configuration information to the source node, where the first measurement configuration information is used by the source node to perform the first sensing measurement.

In some embodiments, the first measurement configuration information is included in the first measurement request.

In some embodiments, the first device is the same as the source node; and
the sensing manner switching apparatus 300 further includes:
a third sending module, configured to send the first measurement report to a second device, where the second device includes a core network node or a network side device accessed by the source node.

In some embodiments, the first device is the same as the source node; and
the obtaining module 301, for example, is configured to:
obtain the first measurement report in a case that it is determined that a target event occurs, where
the target event includes at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a third preset threshold; and
a measurement value of a communication measurement quantity of the source node reaches a fourth preset threshold.

In some embodiments, the sensing manner switching apparatus 300 further includes:
a fourth sending module, configured to: send a first request message to N first candidate nodes in a case that it is determined to initiate switching of the sensing manner of the sensing target from the first sensing manner to the second sensing manner, where the first request message is used to request at least one target candidate node to perform sensing measurement on the sensing target in the second sensing manner, and N is an integer greater than or equal to 1; and
receive a feedback message sent by at least one of the N first candidate nodes, where the feedback message is used to indicate whether the target candidate node agrees to perform sensing measurement on the sensing target in the second sensing manner.

In some embodiments, the feedback message includes at least one of the following:
a first feedback message determined by the first candidate node based on the first request message and used to indicate whether the first candidate node agrees to perform sensing measurement on the sensing target in the second sensing manner, where the target candidate node includes the first candidate node; and
a second feedback message determined by a second candidate node based on a second request message sent by the first candidate node and used to indicate whether the second candidate node agrees to perform sensing measurement on the sensing target in the second sensing manner, where the second request message is used to request the second candidate node to perform sensing measurement on the sensing target in the second sensing manner, and the target candidate node includes the second candidate node.

In some embodiments, the sensing manner switching apparatus 300 further includes:
a fifth sending module, configured to send a first indication message to a second device, where the second device includes a core network node, the source node, or a source access base station of the source node, and the first indication message is used to indicate that the sensing manner of the sensing target is switched from the first sensing manner to the second sensing manner.

In some embodiments, the sensing manner switching apparatus 300 further includes:
a second determining module, configured to determine an interaction type of the second sensing manner in a case that it is determined to initiate switching of the sensing manner of the sensing target from the first sensing manner to the second sensing manner; and
the sending, by the first device, a first request message to N first candidate nodes includes:
sending, by the first device, the first request message to the N first candidate nodes based on the interaction type of the second sensing manner, where
the interaction type of the second sensing manner includes any one of the following:
a first interaction type, where the signal sending node and the signal receiving node in the second sensing manner are two different network side devices;
a second interaction type, where one of the signal sending node and the signal receiving node in the second sensing manner is a network side device and the other is a terminal; and
a third interaction type, where the signal sending node and the signal receiving node in the second sensing manner are two different terminals.

In some embodiments, the sensing manner switching apparatus 300 determines the N first candidate nodes based on at least one of the following:
location information of a candidate node;
antenna panel orientation information of a candidate node;
state information of a candidate node;
sensing capability information of a candidate node;
information about an available sensing resource of a candidate node; and
channel state information of a candidate node.

In some embodiments, in a case that the feedback message is used to indicate that the target candidate node agrees to perform sensing measurement on the sensing target in the second sensing manner, the feedback message further includes first parameter configuration information, and the first parameter configuration information is sensing parameter configuration information used to instruct the target candidate node to perform sensing measurement on the sensing target.

In some embodiments, the sensing manner switching apparatus 300 further includes:
a third determining module, configured to: in a case that the feedback message is used to indicate that the target candidate node agrees to perform sensing measurement on the sensing target in the second sensing manner, determine M target nodes from the target candidate node based on the feedback message, where M is an integer greater than or equal to 1; and
a sixth sending module, configured to send a first notification message to the M target nodes, where the first notification message is used to instruct the M target nodes to perform sensing measurement on the sensing target in the second sensing manner.

In some embodiments, the first notification message includes second parameter configuration information, and the second parameter configuration information is sensing parameter configuration information used to instruct the target node to perform sensing measurement on the sensing target.

In some embodiments, the first device is the same as the source node; and
one of the M target nodes is the source node or none of the M target nodes is the source node.

In some embodiments, the sensing manner switching apparatus 300 further includes:
a seventh sending module, configured to send first information to the M target nodes, where the first information includes at least one of the following:
a value of historical measurement on a sensing measurement quantity of the sensing target by the source node;
a result of historical sensing on the sensing target by the source node;
indication information of the sensing target; and
prior information of a sensing area in which the sensing target is located.

In some embodiments, the first device is different from the source node, and the sensing manner switching apparatus 300 further includes:
an eighth sending module, configured to send a second notification message to the source node, where the second notification message is used to instruct the source node to stop performing sensing measurement on the sensing target in the first sensing manner.

In some embodiments, the eighth sending module is configured to:
send the second notification message to the source node in a case that a third notification message is received, where the third notification message is used to indicate that the target node performs at least one sensing measurement on the sensing target in the second sensing manner and obtains at least one measurement value of a sensing measurement quantity or at least one sensing result.

In some embodiments, the first device is the same as the source node, and the sensing manner switching apparatus 300 further includes:
a control module, configured to control the first device to stop performing sensing measurement on the sensing target in the first sensing manner.

In some embodiments, the control module is configured to:
in a case that a fourth notification message is received, control the first device to stop performing sensing measurement on the sensing target in the first sensing manner, where the fourth notification message is used to indicate that the target node performs at least one sensing measurement on the sensing target in the second sensing manner and obtains at least one measurement value of a sensing measurement quantity or at least one sensing result.

In some embodiments, the first measurement report includes at least one of the following:
at least one measurement value of a sensing measurement quantity;
at least one measurement result of a sensing performance evaluation indicator;
at least one measurement value of a communication measurement quantity;
at least one measurement result of a communication performance evaluation indicator;
first indication information used to indicate whether a preset event occurs, where the preset event is used to trigger the initiation of switching the sensing manner of the sensing target from the first sensing manner to the second sensing manner; and
second indication information used to indicate whether a preset switching condition is met, where the preset switching condition is used to trigger the initiation of switching the sensing manner of the sensing target from the first sensing manner to the second sensing manner.

In conclusion, in a scenario in which a sensing node performs sensing measurement on the sensing target in the first sensing manner, switching of the sensing manner of the sensing target from the first sensing manner to the second sensing manner is initiated, so that the sensing measurement can be performed in a proper sensing manner, thereby improving reliability of the sensing measurement.

The sensing manner switching apparatus 300 in this embodiment of this application may be an electronic device, for example, an electronic device with an operating system, or may be a component in the electronic device, for example, an integrated circuit or a chip. The electronic device may be a terminal, or may be a network side device. For example, the terminal may include but is not limited to the foregoing listed type of the terminal 11, and the network side device may include but is not limited to the foregoing listed type of the network side device 12. This is not specifically limited in this embodiment of this application.

The sensing manner switching apparatus 300 provided in this embodiment of this application can implement the processes implemented in the method embodiment of FIG. 2, and achieve a same technical effect. To avoid repetition, details are not described herein again.

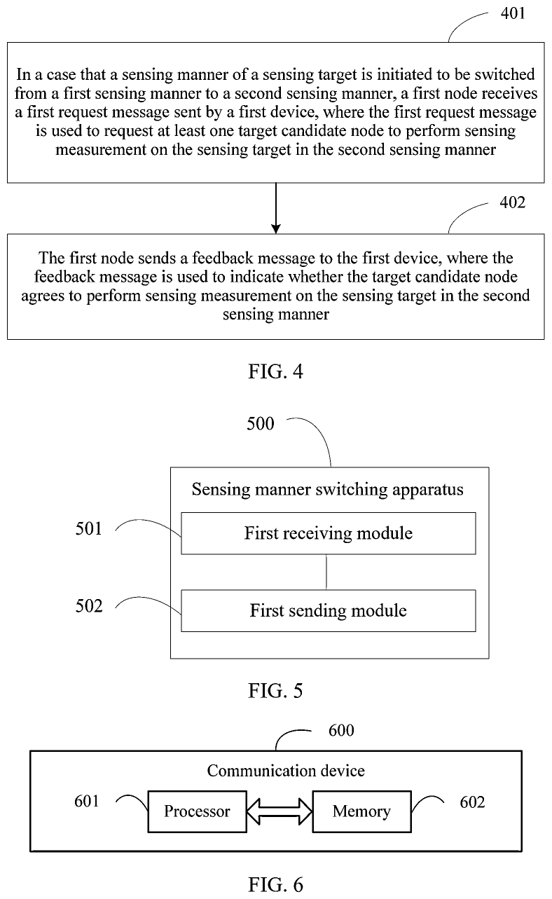

FIG. 4 is a flowchart of a sensing manner switching method according to an embodiment of this application. As shown in FIG. 4, the sensing manner switching method includes the following steps.

Step 401: In a case that a sensing manner of a sensing target is initiated to be switched from a first sensing manner to a second sensing manner, a first node receives a first request message sent by a first device, where the first request message is used to request at least one target candidate node to perform sensing measurement on the sensing target in the second sensing manner, a signal sending node and a signal receiving node in the first sensing manner are a same node, and a signal sending node in the second sensing manner and a signal receiving node in the second sensing manner are different nodes.

Step 402: The first node sends a feedback message to the first device, where the feedback message is used to indicate whether the target candidate node agrees to perform sensing measurement on the sensing target in the second sensing manner.

It should be noted that the first node in this embodiment of this application may be a candidate node or a source node, and the first node may include a network side device or a terminal.

In some embodiments, the feedback message includes at least one of the following:
a first feedback message determined by the first node based on the first request message and used to indicate whether the first node agrees to perform sensing measurement on the sensing target in the second sensing manner, where the target candidate node includes the first node; and
a second feedback message determined by a second node based on a second request message sent by the first node and used to indicate whether the second node agrees to perform sensing measurement on the sensing target in the second sensing manner, where the second request message is used to request the second node to perform sensing measurement on the sensing target in the second sensing manner, and the target candidate node includes the second node.

In some embodiments, the first request message further includes indication information used to indicate an interaction type of the second sensing manner; and
after the receiving, by a first node, a first request message sent by a first device, the method further includes:
sending, by the first node, the second request message to the second node based on the interaction type of the second sensing manner, where
the interaction type of the second sensing manner includes any one of the following:
a first interaction type, where the signal sending node and the signal receiving node in the second sensing manner are two different network side devices;
a second interaction type, where one of the signal sending node and the signal receiving node in the second sensing manner is a network side device and the other is a terminal; and
a third interaction type, where the signal sending node and the signal receiving node in the second sensing manner are two different terminals.

In some embodiments, in a case that the feedback message is used to indicate that the target candidate node agrees to perform sensing measurement on the sensing target in the second sensing manner, the feedback message further includes first parameter configuration information, and the first parameter configuration information is sensing parameter configuration information used to instruct the target candidate node to perform sensing measurement on the sensing target.

In some embodiments, the target candidate node includes the first node; and
in a case that the feedback message is used to indicate that the first node agrees to perform sensing measurement on the sensing target in the second sensing manner, the method further includes:
receiving, by the first node, a first notification message sent by the first device, where the first notification message is used to instruct the first node to perform sensing measurement on the sensing target in the second sensing manner; and
performing, by the first node, sensing measurement on the sensing target in the second sensing manner.

In some embodiments, the first notification message includes second parameter configuration information, and the second parameter configuration information is sensing parameter configuration information used to instruct the first node to perform sensing measurement on the sensing target.

In some embodiments, the method further includes:
receiving, by the first node, first information sent by the first device, where the first information includes at least one of the following:
a value of historical measurement on a sensing measurement quantity of the sensing target by a source node;
a result of historical sensing on the sensing target by the source node;
indication information of the sensing target; and
prior information of a sensing area in which the sensing target is located.

In some embodiments, the method further includes:
sending, by the first node, a third notification message to the first device, where the third notification message is used to indicate that the first node performs at least one sensing measurement on the sensing target in the second sensing manner and obtains at least one measurement value of a sensing measurement quantity or at least one sensing result.

In conclusion, in a scenario in which a sensing node performs sensing measurement on the sensing target in the first sensing manner, switching of the sensing manner of the sensing target from the first sensing manner to the second sensing manner is initiated, so that the sensing measurement can be performed in a proper sensing manner, thereby improving reliability of the sensing measurement.

The sensing manner switching method provided in the embodiments of this application may be performed by a sensing manner switching apparatus. In the embodiments of this application, an example in which the sensing manner switching apparatus performs the sensing manner switching method is used to describe the sensing manner switching apparatus provided in the embodiments of this application.

Referring to FIG. 5, an embodiment of this application further provides a sensing manner switching apparatus, which may be applied to a first node. As shown in FIG. 5, the sensing manner switching apparatus 500 includes:
a first receiving module 501, configured to: in a case that a sensing manner of a sensing target is initiated to be switched from a first sensing manner to a second sensing manner, receive a first request message sent by a first device, where the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and
a first sending module 502, configured to send a feedback message to the first device, where the feedback message is used to indicate whether the target candidate node agrees to perform sensing measurement on the sensing target in the second sensing manner.

In some embodiments, the feedback message includes at least one of the following:
a first feedback message determined by the first node based on the first request message and used to indicate whether the first node agrees to perform sensing measurement on the sensing target in the second sensing manner, where the target candidate node includes the first node; and
a second feedback message determined by a second node based on a second request message sent by the first node and used to indicate whether the second node agrees to perform sensing measurement on the sensing target in the second sensing manner, where the second request message is used to request the second node to perform sensing measurement on the sensing target in the second sensing manner, and the target candidate node includes the second node.

In some embodiments, the first request message further includes indication information used to indicate an interaction type of the second sensing manner; and
the sensing manner switching apparatus 500 further includes:
a second sending module, configured to send the second request message to the second node based on the interaction type of the second sensing manner, where
the interaction type of the second sensing manner includes any one of the following:
a first interaction type, where the signal sending node and the signal receiving node in the second sensing manner are two different network side devices;
a second interaction type, where one of the signal sending node and the signal receiving node in the second sensing manner is a network side device and the other is a terminal; and
a third interaction type, where the signal sending node and the signal receiving node in the second sensing manner are two different terminals.

In some embodiments, in a case that the feedback message is used to indicate that the target candidate node agrees to perform sensing measurement on the sensing target in the second sensing manner, the feedback message further includes first parameter configuration information, and the first parameter configuration information is sensing parameter configuration information used to instruct the target candidate node to perform sensing measurement on the sensing target.

In some embodiments, the target candidate node includes the first node; and
the sensing manner switching apparatus 500 further includes:
a second receiving module, configured to: in a case that the feedback message is used to indicate that the first node agrees to perform sensing measurement on the sensing target in the second sensing manner, receive a first notification message sent by the first device, where the first notification message is used to instruct the first node to perform sensing measurement on the sensing target in the second sensing manner; and
a sensing module, configured to perform sensing measurement on the sensing target in the second sensing manner.

In some embodiments, the first notification message includes second parameter configuration information, and the second parameter configuration information is sensing parameter configuration information used to instruct the first node to perform sensing measurement on the sensing target.

In some embodiments, the sensing manner switching apparatus 500 further includes:
a third receiving module, configured to receive first information sent by the first device, where the first information includes at least one of the following:
a value of historical measurement on a sensing measurement quantity of the sensing target by a source node;
a result of historical sensing on the sensing target by the source node;
indication information of the sensing target; and
prior information of a sensing area in which the sensing target is located.

In some embodiments, the sensing manner switching apparatus 500 further includes:
a third sending module, configured to send a third notification message to the first device, where the third notification message is used to indicate that the first node performs at least one sensing measurement on the sensing target in the second sensing manner and obtains at least one measurement value of a sensing measurement quantity or at least one sensing result.

In conclusion, in a scenario in which a sensing node performs sensing measurement on the sensing target in the first sensing manner, switching of the sensing manner of the sensing target from the first sensing manner to the second sensing manner is initiated, so that the sensing measurement can be performed in a proper sensing manner, thereby improving reliability of the sensing measurement.

The sensing manner switching apparatus 500 in this embodiment of this application may be an electronic device, for example, an electronic device with an operating system, or may be a component in the electronic device, for example, an integrated circuit or a chip. The electronic device may be a terminal, or may be a network side device. For example, the terminal may include but is not limited to the foregoing listed type of the terminal 11, and the network side device may include but is not limited to the foregoing listed type of the network side device 12. This is not specifically limited in this embodiment of this application.

The sensing manner switching apparatus 500 provided in this embodiment of this application can implement the processes implemented in the method embodiment of FIG. 4, and achieve a same technical effect. To avoid repetition, details are not described herein again.

In some embodiments, as shown in FIG. 6, an embodiment of this application further provides a communication device 600, including a processor 601 and a memory 602, where the memory 602 stores a program or an instruction that can be run on the processor 601. For example, when the communication device 600 is a terminal, the program or the instruction is executed by the processor 601 to implement the steps of the foregoing sensing manner switching method embodiment, and a same technical effect can be achieved. When the communication device 600 is a network side device, the program or the instruction is executed by the processor 601 to implement the steps of the foregoing sensing manner switching method embodiment, and a same technical effect can be achieved. To avoid repetition, details are not described herein again.

An embodiment of this application further provides a communication device. The communication device is a terminal or a network side device, and the communication device includes a processor and a communication interface. The communication interface is configured to obtain a first measurement report, where the first measurement report is generated by a source node by performing first sensing measurement on a sensing target in a first sensing manner, a signal sending node in the first sensing manner and a signal receiving node in the first sensing manner are a same node, and the first device is the same as or different from the source node; and the processor is configured to determine, based on the first measurement report, whether to initiate switching of a sensing manner of the sensing target from the first sensing manner to a second sensing manner, where a signal sending node in the second sensing manner and a signal receiving node in the second sensing manner are different nodes.

An embodiment of this application further provides a communication device. The communication device is a terminal or a network side device, and the communication device includes a processor and a communication interface. The communication interface is configured to: in a case that a sensing manner of a sensing target is initiated to be switched from a first sensing manner to a second sensing manner, receive a first request message sent by a first device, where the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and the communication interface is further configured to send a feedback message to the first device, where the feedback message is used to indicate whether the target candidate node agrees to perform sensing measurement on the sensing target in the second sensing manner.

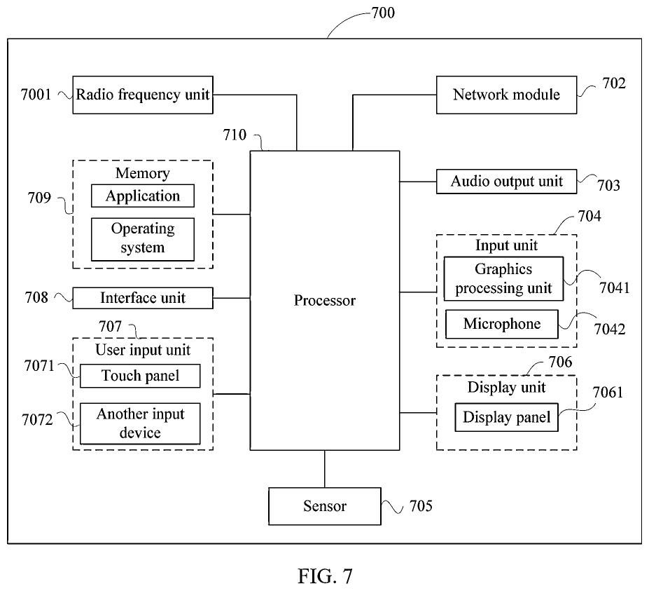

Each implementation process and implementation of the foregoing method embodiment may be applied to a terminal, and a same technical effect can be achieved. In some embodiments, FIG. 7 is a schematic structural diagram of hardware of a terminal according to an embodiment of this application.

The terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

A person skilled in the art can understand that the terminal 700 may further include the power supply (for example, a battery) that supplies power to each component. The power supply may be logically connected to the processor 710 by using a power supply management system, so as to manage functions such as charging, discharging, and power consumption by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still image or a video that is obtained by an image capturing apparatus (for example, a camera) in a video capturing mode or an image capturing mode. The display unit 706 may include a display panel 7061. The display panel 7061 may be configured in a form such as a liquid crystal display or an organic light-emitting diode. The user input unit 707 includes at least one of a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (for example, a volume control button or a power on/off button), a trackball, a mouse, and a joystick. Details are not described herein.

In this embodiment of this application, after receiving downlink data from a network side device, the radio frequency unit 701 may transmit the downlink data to the processor 710 for processing. In addition, the radio frequency unit 701 may send uplink data to the network side device. Usually, the radio frequency unit 701 includes but is not limited to an antenna, an amplifier, a transceiver, a coupler, a low noise amplifier, a duplexer, and the like.

The memory 709 may be configured to store a software program or an instruction and various data. The memory 709 may mainly include a first storage area for storing a program or an instruction and a second storage area for storing data. The first storage area may store an operating system, and an application or an instruction required by at least one function (for example, a sound playing function or an image playing function). In addition, the memory 709 may be a volatile memory or a non-volatile memory, or the memory 709 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 709 in this embodiment of this application includes but is not limited to these memories and a memory of any other proper type.

The processor 710 may include one or more processing units. In some embodiments, an application processor and a modem processor are integrated into the processor 710. The application processor mainly processes an operating system, a user interface, an application, and the like. The modem processor mainly processes a wireless communication signal, for example, a baseband processor. It can be understood that, in some embodiments, the modem processor may not be integrated into the processor 710.

The terminal 700 may be used as a first device to perform the steps of the sensing manner switching method in the embodiments of this application, or may be used as a first node to perform the steps of the sensing manner switching method in the embodiments of this application.

In one aspect, the terminal 700 may be used as the first device to perform the following steps:

The radio frequency unit 701 is configured to obtain a first measurement report, where the first measurement report is generated by a source node by performing first sensing measurement on a sensing target in a first sensing manner, a signal sending node in the first sensing manner and a signal receiving node in the first sensing manner are a same node.

The processor 710 is configured to determine, based on the first measurement report, whether to initiate switching of a sensing manner of the sensing target from the first sensing manner to a second sensing manner, where a signal sending node in the second sensing manner and a signal receiving node in the second sensing manner are different nodes.

In some embodiments, the terminal 700 is not the source node; and
the radio frequency unit 701 is further configured to:
send a first measurement request to the source node, where the first measurement request is used to request the source node to perform the first sensing measurement on the sensing target in the first sensing manner; and
receive the first measurement report sent by the source node, where the first measurement report is generated by the source node based on the first sensing measurement.

In some embodiments, the radio frequency unit 701 is further configured to:
send the first measurement request to the source node in a case that it is determined that a target event occurs, where
the target event includes at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a first preset threshold; and
a measurement value of a communication measurement quantity of the source node reaches a second preset threshold.

In some embodiments, the radio frequency unit 701 is further configured to:
send first measurement configuration information to the source node, where the first measurement configuration information is used by the source node to perform the first sensing measurement.

In some embodiments, the first measurement configuration information is included in the first measurement request.

In some embodiments, the terminal 700 is the source node; and
the radio frequency unit 701 is further configured to:
send the first measurement report to a second device, where the second device includes a core network node or a network side device accessed by the source node.

In some embodiments, the terminal 700 is the source node; and
the radio frequency unit 701 is further configured to:
obtain, by the first device, the first measurement report in a case that it is determined that a target event occurs, where
the target event includes at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a third preset threshold; and
a measurement value of a communication measurement quantity of the source node reaches a fourth preset threshold.

In some embodiments, the radio frequency unit 701 is further configured to:
send a first request message to N first candidate nodes in a case that it is determined to initiate switching of the sensing manner of the sensing target from the first sensing manner to the second sensing manner, where the first request message is used to request at least one target candidate node to perform sensing measurement on the sensing target in the second sensing manner, and N is an integer greater than or equal to 1; and
receive a feedback message sent by at least one of the N first candidate nodes, where the feedback message is used to indicate whether the target candidate node agrees to perform sensing measurement on the sensing target in the second sensing manner.

In some embodiments, the feedback message includes at least one of the following:
a first feedback message determined by the first candidate node based on the first request message and used to indicate whether the first candidate node agrees to perform sensing measurement on the sensing target in the second sensing manner, where the target candidate node includes the first candidate node; and
a second feedback message determined by a second candidate node based on a second request message sent by the first candidate node and used to indicate whether the second candidate node agrees to perform sensing measurement on the sensing target in the second sensing manner, where the second request message is used to request the second candidate node to perform sensing measurement on the sensing target in the second sensing manner, and the target candidate node includes the second candidate node.

In some embodiments, the radio frequency unit 701 is further configured to:
send, by the first device, a first indication message to a second device, where the second device includes a core network node, the source node, or a source access base station of the source node, and the first indication message is used to indicate that the sensing manner of the sensing target is switched from the first sensing manner to the second sensing manner.

In some embodiments, the processor 710 is further configured to:
determine an interaction type of the second sensing manner in a case that it is determined to initiate switching of the sensing manner of the sensing target from the first sensing manner to the second sensing manner; and
the radio frequency unit 701 is further configured to:
send the first request message to the N first candidate nodes based on the interaction type of the second sensing manner, where
the interaction type of the second sensing manner includes any one of the following:
a first interaction type, where the signal sending node and the signal receiving node in the second sensing manner are two different network side devices;
a second interaction type, where one of the signal sending node and the signal receiving node in the second sensing manner is a network side device and the other is a terminal; and
a third interaction type, where the signal sending node and the signal receiving node in the second sensing manner are two different terminals.

In some embodiments, the processor 710 is further configured to:
determine he N first candidate nodes based on at least one of the following:
location information of a candidate node;
antenna panel orientation information of a candidate node;
state information of a candidate node;
sensing capability information of a candidate node;
information about an available sensing resource of a candidate node; and
channel state information of a candidate node.

In some embodiments, in a case that the feedback message is used to indicate that the target candidate node agrees to perform sensing measurement on the sensing target in the second sensing manner, the feedback message further includes first parameter configuration information, and the first parameter configuration information is sensing parameter configuration information used to instruct the target candidate node to perform sensing measurement on the sensing target.

In some embodiments, the processor 710 is further configured to:
in a case that the feedback message is used to indicate that the target candidate node agrees to perform sensing measurement on the sensing target in the second sensing manner, determine M target nodes from the target candidate node based on the feedback message, where M is an integer greater than or equal to 1; and
the radio frequency unit 701 is further configured to:
send a first notification message to the M target nodes, where the first notification message is used to instruct the M target nodes to perform sensing measurement on the sensing target in the second sensing manner.

In some embodiments, the first notification message includes second parameter configuration information, and the second parameter configuration information is sensing parameter configuration information used to instruct the target node to perform sensing measurement on the sensing target.

In some embodiments, the terminal 700 is the source node; and
the M target nodes include the terminal 700, or the M target nodes do not include the terminal 700.

In some embodiments, the radio frequency unit 701 is further configured to:
send first information to the M target nodes, where the first information includes at least one of the following:
a value of historical measurement on a sensing measurement quantity of the sensing target by the source node;
a result of historical sensing on the sensing target by the source node;
indication information of the sensing target; and
prior information of a sensing area in which the sensing target is located.

In some embodiments, the terminal 700 is not the source node, and the radio frequency unit 701 is further configured to:
send a second notification message to the source node, where the second notification message is used to instruct the source node to stop performing sensing measurement on the sensing target in the first sensing manner.

In some embodiments, the radio frequency unit 701 is further configured to:
send the second notification message to the source node in a case that a third notification message is received, where the third notification message is used to indicate that the target node performs at least one sensing measurement on the sensing target in the second sensing manner and obtains at least one measurement value of a sensing measurement quantity or at least one sensing result.

In some embodiments, the terminal 700 is the source node, and the processor 710 is further configured to:
stop performing sensing measurement on the sensing target in the first sensing manner.

In some embodiments, the processor 710 is further configured to:
stop performing sensing measurement on the sensing target in the first sensing manner in a case that a fourth notification message is received, where the fourth notification message is used to indicate that the target node performs at least one sensing measurement on the sensing target in the second sensing manner and obtains at least one measurement value of a sensing measurement quantity or at least one sensing result.

In some embodiments, the first measurement report includes at least one of the following:
at least one measurement value of a sensing measurement quantity;
at least one measurement result of a sensing performance evaluation indicator;
at least one measurement value of a communication measurement quantity;
at least one measurement result of a communication performance evaluation indicator;
first indication information used to indicate whether a preset event occurs, where the preset event is used to trigger the initiation of switching the sensing manner of the sensing target from the first sensing manner to the second sensing manner; and
second indication information used to indicate whether a preset switching condition is met, where the preset switching condition is used to trigger the initiation of switching the sensing manner of the sensing target from the first sensing manner to the second sensing manner.

In another aspect, the terminal 700 may be used as the first node to perform the following steps:

The radio frequency unit 701 is configured to:
in a case that a sensing manner of a sensing target is initiated to be switched from a first sensing manner to a second sensing manner, receive a first request message sent by a first device, where the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and
send a feedback message to the first device, where the feedback message is used to indicate whether the target candidate node agrees to perform sensing measurement on the sensing target in the second sensing manner.

In some embodiments, the feedback message includes at least one of the following:
a first feedback message determined by the first node based on the first request message and used to indicate whether the first node agrees to perform sensing measurement on the sensing target in the second sensing manner, where the target candidate node includes the first node; and
a second feedback message determined by a second node based on a second request message sent by the first node and used to indicate whether the second node agrees to perform sensing measurement on the sensing target in the second sensing manner, where the second request message is used to request the second node to perform sensing measurement on the sensing target in the second sensing manner, and the target candidate node includes the second node.

In some embodiments, the first request message further includes indication information used to indicate an interaction type of the second sensing manner; and
the radio frequency unit 701 is further configured to:
send the second request message to the second node based on the interaction type of the second sensing manner, where
the interaction type of the second sensing manner includes any one of the following:
a first interaction type, where the signal sending node and the signal receiving node in the second sensing manner are two different network side devices;
a second interaction type, where one of the signal sending node and the signal receiving node in the second sensing manner is a network side device and the other is a terminal; and
a third interaction type, where the signal sending node and the signal receiving node in the second sensing manner are two different terminals.

In some embodiments, in a case that the feedback message is used to indicate that the target candidate node agrees to perform sensing measurement on the sensing target in the second sensing manner, the feedback message further includes first parameter configuration information, and the first parameter configuration information is sensing parameter configuration information used to instruct the target candidate node to perform sensing measurement on the sensing target.

In some embodiments, the target candidate node includes the first node; and
the radio frequency unit 701 is further configured to:
in a case that the feedback message is used to indicate that the first node agrees to perform sensing measurement on the sensing target in the second sensing manner, receive a first notification message sent by the first device, where the first notification message is used to instruct the first node to perform sensing measurement on the sensing target in the second sensing manner; and
perform sensing measurement on the sensing target in the second sensing manner.

In some embodiments, the first notification message includes second parameter configuration information, and the second parameter configuration information is sensing parameter configuration information used to instruct the first node to perform sensing measurement on the sensing target.

In some embodiments, the radio frequency unit 701 is further configured to:
receive first information sent by the first device, where the first information includes at least one of the following:
a value of historical measurement on a sensing measurement quantity of the sensing target by a source node;
a result of historical sensing on the sensing target by the source node;
indication information of the sensing target; and
prior information of a sensing area in which the sensing target is located.

In some embodiments, the radio frequency unit 701 is further configured to:
send a third notification message to the first device, where the third notification message is used to indicate that the first node performs at least one sensing measurement on the sensing target in the second sensing manner and obtains at least one measurement value of a sensing measurement quantity or at least one sensing result.

In conclusion, in a scenario in which a sensing node performs sensing measurement on the sensing target in the first sensing manner, switching of the sensing manner of the sensing target from the first sensing manner to the second sensing manner is initiated, so that the sensing measurement can be performed in a proper sensing manner, thereby improving reliability of the sensing measurement.

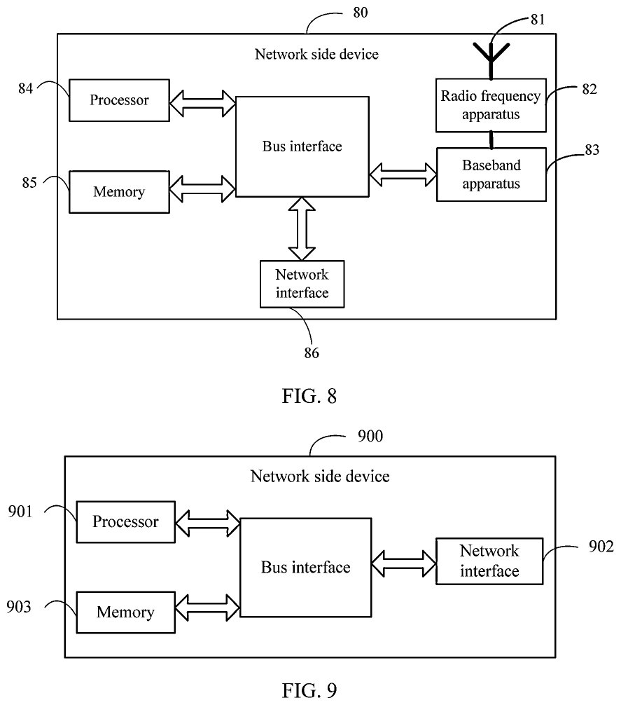

Each implementation process and implementation of the foregoing method embodiment may be further applied to a network side device, and a same technical effect can be achieved. In some embodiments, FIG. 8 is a schematic structural diagram of hardware of a network side device according to an embodiment of this application. As shown in FIG. 8, the network side device 80 includes an antenna 81, a radio frequency apparatus 82, a baseband apparatus 83, a processor 84, and a memory 85. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

In the foregoing embodiment, the method performed by the network side device may be implemented in the baseband apparatus 83. The baseband apparatus 83 includes a baseband processor.

The baseband apparatus 83 may include, for example, at least one baseband board, where a plurality of chips are disposed on the baseband board. As shown in FIG. 8, one chip is, for example, the baseband processor, is connected to the memory 85 through a bus interface, to invoke a program in the memory 85 to perform the operations of the network device shown in the foregoing method embodiment.

The network side device may further include a network interface 86, and the interface is, for example, a common public radio interface (CPRI).

In some embodiments, the network side device 80 in this embodiment of this application further includes an instruction or a program that is stored in the memory 85 and that can be run on the processor 84. The processor 84 invokes the instruction or the program in the memory 85 to perform the method performed by the modules shown in FIG. 3 or FIG. 5, and a same technical effect is achieved. To avoid repetition, details are not described herein again.

In some embodiments, an embodiment of this application further provides a network side device. As shown in FIG. 9, a network side device 900 includes a processor 901, a network interface 902, and a memory 903. The network interface 902 is, for example, a common public radio interface (CPRI).

In some embodiments, the network side device 900 in this embodiment of this application further includes an instruction or a program that is stored in the memory 903 and that can be run on the processor 901. The processor 901 invokes the instruction or the program in the memory 903 to perform the method performed by the modules shown in FIG. 3 or FIG. 5, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing sensing manner switching method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing sensing manner switching method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing sensing manner switching method embodiment, and a same technical effect can be achieved. To avoid repetition, details are not described herein again.

An embodiment of this application further provides a communication system, including a terminal and a network side device. The terminal may be configured to perform the steps of the foregoing sensing manner switching method, and the network side device may be configured to perform the steps of the foregoing sensing manner switching method.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the method in the foregoing embodiment may be implemented by software in addition to a necessary universal hardware platform or by hardware only. In most circumstances, the former is an example implementation manner. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are merely illustrative but not restrictive. Under the enlightenment of this application, a person of ordinary skill in the art can make many forms without departing from the purpose of this application and the protection scope of the claims, all of which fall within the protection of this application.

1. A sensing manner switching method, comprising:
obtaining, by a first device, a first measurement report, wherein the first measurement report is generated by a source node by performing first sensing measurement on a sensing target in a first sensing manner, a signal sending node in the first sensing manner and a signal receiving node in the first sensing manner are a same node, and the first device is the same as or different from the source node; and
determining, by the first device based on the first measurement report, whether to initiate switching of a sensing manner of the sensing target from the first sensing manner to a second sensing manner, wherein a signal sending node in the second sensing manner and a signal receiving node in the second sensing manner are different nodes.

2. The method according to claim 1, wherein the first device comprises any one of the following:
when the source node is a first network side device, the first device comprises a core network node or the first network side device; or
when the source node is a first terminal, the first device comprises a core network node, the first terminal, or a second network side device accessed by the first terminal.

3. The method according to claim 1, wherein the first device is different from the source node,
before the obtaining, by the first device, the first measurement report, the method further comprises:
sending, by the first device, a first measurement request to the source node, wherein the first measurement request is used to request the source node to perform the first sensing measurement on the sensing target in the first sensing manner, and
the obtaining, by the first device, the first measurement report comprises:
receiving, by the first device, the first measurement report sent by the source node, wherein the first measurement report is generated by the source node based on the first sensing measurement.

4. The method according to claim 3, wherein the sending, by the first device, the first measurement request to the source node comprises:
sending, by the first device, the first measurement request to the source node when it is determined that a target event occurs, wherein
the target event comprises at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a first preset threshold; or
a measurement value of a communication measurement quantity of the source node reaches a second preset threshold.

5. The method according to claim 3, wherein before the obtaining, by the first device, the first measurement report, the method further comprises:
sending, by the first device, first measurement configuration information to the source node, wherein the first measurement configuration information is used by the source node to perform the first sensing measurement, and
wherein the first measurement configuration information is comprised in the first measurement request.

6. The method according to claim 1, wherein the first device is the same as the source node, and
after the obtaining, by the first device, the first measurement report, the method further comprises:
sending, by the first device, the first measurement report to a second device, wherein the second device comprises a core network node or a network side device accessed by the source node.

7. The method according to claim 1, wherein the first device is the same as the source node, and
the obtaining, by the first device, the first measurement report comprises:
obtaining, by the first device, the first measurement report when it is determined that a target event occurs, wherein
the target event comprises at least one of the following:
a state of the sensing target changes;
a location of the source node changes;
an environment of a sensing area in which the sensing target is located changes;
an available sensing resource of the source node changes;
a measurement value of a sensing measurement quantity of the source node reaches a third preset threshold; or
a measurement value of a communication measurement quantity of the source node reaches a fourth preset threshold.

8. The method according to claim 1, further comprising:
sending, by the first device, a first request message to N first candidate nodes when the first device determines to initiate switching of the sensing manner of the sensing target from the first sensing manner to the second sensing manner, wherein the first request message is used to request at least one target candidate node to perform sensing measurement on the sensing target in the second sensing manner, and N is an integer greater than or equal to 1; and
receiving, by the first device, a feedback message sent by at least one of the N first candidate nodes, wherein the feedback message is used to indicate whether the target candidate node agrees to perform sensing measurement on the sensing target in the second sensing manner.

9. The method according to claim 8, wherein the feedback message comprises at least one of the following:
a first feedback message determined by the first candidate node based on the first request message and used to indicate whether the first candidate node agrees to perform sensing measurement on the sensing target in the second sensing manner, wherein the target candidate node comprises the first candidate node; or
a second feedback message determined by a second candidate node based on a second request message sent by the first candidate node and used to indicate whether the second candidate node agrees to perform sensing measurement on the sensing target in the second sensing manner, wherein the second request message is used to request the second candidate node to perform sensing measurement on the sensing target in the second sensing manner, and the target candidate node comprises the second candidate node, or
wherein after the sending, by the first device, the first request message to N first candidate nodes, the method further comprises:
sending, by the first device, a first indication message to a second device, wherein the second device comprises a core network node, the source node, or a source access base station of the source node, and the first indication message is used to indicate that the sensing manner of the sensing target is switched from the first sensing manner to the second sensing manner.

10. The method according to claim 8, further comprising:
determining, by the first device, an interaction type of the second sensing manner when it is determined to initiate switching of the sensing manner of the sensing target from the first sensing manner to the second sensing manner, and
the sending, by the first device, the first request message to N first candidate nodes comprises:
sending, by the first device, the first request message to the N first candidate nodes based on the interaction type of the second sensing manner, wherein
the interaction type of the second sensing manner comprises any one of the following:
a first interaction type, wherein the signal sending node and the signal receiving node in the second sensing manner are two different network side devices;
a second interaction type, wherein one of the signal sending node and the signal receiving node in the second sensing manner is a network side device and the other is a terminal; or
a third interaction type, wherein the signal sending node and the signal receiving node in the second sensing manner are two different terminals.

11. The method according to claim 8, wherein the first device determines the N first candidate nodes based on at least one of the following:
location information of a candidate node;
antenna panel orientation information of a candidate node;
state information of a candidate node;
sensing capability information of a candidate node;
information about an available sensing resource of a candidate node; or
channel state information of a candidate node, or
wherein when the feedback message is used to indicate that the target candidate node agrees to perform sensing measurement on the sensing target in the second sensing manner, the feedback message further comprises first parameter configuration information, and the first parameter configuration information is sensing parameter configuration information used to instruct the target candidate node to perform sensing measurement on the sensing target.

12. The method according to claim 8, wherein when the feedback message is used to indicate that the target candidate node agrees to perform sensing measurement on the sensing target in the second sensing manner, the method further comprises:
determining, by the first device, M target nodes from the target candidate node based on the feedback message, wherein M is an integer greater than or equal to 1; and
sending, by the first device, a first notification message to the M target nodes, wherein the first notification message is used to instruct the M target nodes to perform sensing measurement on the sensing target in the second sensing manner.

13. The method according to claim 12, wherein the first notification message comprises second parameter configuration information, and the second parameter configuration information is sensing parameter configuration information used to instruct the target node to perform sensing measurement on the sensing target, or
wherein the first device is the same as the source node, and one of the M target nodes is the source node or none of the M target nodes is the source node, or
wherein the method further comprises:
sending, by the first device, first information to the M target nodes, wherein the first information comprises at least one of the following:
a value of historical measurement on a sensing measurement quantity of the sensing target by the source node;
a result of historical sensing on the sensing target by the source node;
indication information of the sensing target; or
prior information of a sensing area in which the sensing target is located.

14. The method according to claim 12, wherein the first device is different from the source node, and the method further comprises:
sending, by the first device, a second notification message to the source node, wherein the second notification message is used to instruct the source node to stop performing sensing measurement on the sensing target in the first sensing manner, and
wherein the sending, by the first device, the second notification message to the source node comprises:
sending, by the first device, the second notification message to the source node when a third notification message is received, wherein the third notification message is used to indicate that the target node performs at least one sensing measurement on the sensing target in the second sensing manner and obtains at least one measurement value of a sensing measurement quantity or at least one sensing result.

15. The method according to claim 12, wherein the first device is the same as the source node, and the method further comprises:
stopping, by the first device, performing sensing measurement on the sensing target in the first sensing manner,
wherein the stopping, by the first device, performing sensing measurement on the sensing target in the first sensing manner comprises:
stopping, by the first device, performing sensing measurement on the sensing target in the first sensing manner when a fourth notification message is received, wherein the fourth notification message is used to indicate that the target node performs at least one sensing measurement on the sensing target in the second sensing manner and obtains at least one measurement value of a sensing measurement quantity or at least one sensing result.

16. The method according to claim 1, wherein the first measurement report comprises at least one of the following:
at least one measurement value of a sensing measurement quantity;
at least one measurement result of a sensing performance evaluation indicator;
at least one measurement value of a communication measurement quantity;
at least one measurement result of a communication performance evaluation indicator;
first indication information used to indicate whether a preset event occurs, wherein the preset event is used to trigger the initiation of switching the sensing manner of the sensing target from the first sensing manner to the second sensing manner; or
second indication information used to indicate whether a preset switching condition is met, wherein the preset switching condition is used to trigger the initiation of switching the sensing manner of the sensing target from the first sensing manner to the second sensing manner.

17. A sensing manner switching method, comprising:
when a sensing manner of a sensing target is initiated to be switched from a first sensing manner to a second sensing manner, receiving, by a first node, a first request message sent by a first device, wherein the first request message is used to request at least one target candidate node to perform sensing measurement on the sensing target in the second sensing manner, a signal sending node in the first sensing manner and a signal receiving node in the first sensing manner are a same node, and a signal sending node in the second sensing manner and a signal receiving node in the second sensing manner are different nodes; and
sending, by the first node, a feedback message to the first device, wherein the feedback message is used to indicate whether the target candidate node agrees to perform sensing measurement on the sensing target in the second sensing manner.

18. The method according to claim 17, wherein the first request message further comprises indication information used to indicate an interaction type of the second sensing manner, and
after the receiving, by the first node, the first request message sent by a first device, the method further comprises:
sending, by the first node, the second request message to the second node based on the interaction type of the second sensing manner, wherein
the interaction type of the second sensing manner comprises any one of the following:
a first interaction type, wherein the signal sending node and the signal receiving node in the second sensing manner are two different network side devices;
a second interaction type, wherein one of the signal sending node and the signal receiving node in the second sensing manner is a network side device and the other is a terminal; or
a third interaction type, wherein the signal sending node and the signal receiving node in the second sensing manner are two different terminals.

19. The method according to claim 17, wherein the target candidate node comprises the first node, and
when the feedback message is used to indicate that the first node agrees to perform sensing measurement on the sensing target in the second sensing manner, the method further comprises:
receiving, by the first node, a first notification message sent by the first device, wherein the first notification message is used to instruct the first node to perform sensing measurement on the sensing target in the second sensing manner; and
performing, by the first node, sensing measurement on the sensing target in the second sensing manner.

20. A communication device, comprising a processor and a memory storing instructions, wherein the instructions, when executed by the processor, cause the processor to perform operations comprising
obtaining a first measurement report, wherein the first measurement report is generated by a source node by performing first sensing measurement on a sensing target in a first sensing manner, wherein a signal sending node in the first sensing manner and a signal receiving node in the first sensing manner are a same node, and the first device is the same as or different from the source node; and
determining whether to initiate switching of a sensing manner of the sensing target from the first sensing manner to a second sensing manner based on the first measurement report, wherein a signal sending node in the second sensing manner and a signal receiving node in the second sensing manner are different nodes.
